(19) United States
(12) Patent Application Publication
(10) Pub. No.: US 2026/0188192 A1
(43) Pub. Date: Jul. 2, 2026

(54) ELECTRONIC DEVICE

(71) Applicant: Samsung Display Co., Ltd., Yongin-si (KR)

(72) Inventors: KYUNGHO KIM, Yongin-si (KR); BYUNGCHANG YU, Yongin-si (KR); JINJOO HA, Yongin-si (KR)

(21) Appl. No.: 19/371,674

(22) Filed: Oct. 28, 2025

(30) Foreign Application Priority Data
Dec. 26, 2024 (KR) 10-2024-0196747

(51) Int. Cl. G09G 3/32

(52) U.S. Cl. CPC G09G 3/32; G09G 2300/0819; G09G 2300/0852; G09G 2300/0861; G09G 2310/0275; G09G 2310/04; G09G 2310/08; G09G 2330/021

(57) ABSTRACT

An electronic device including a display panel including a pixel circuit, a gate emission driver to output gate signals, a data driver to apply data voltages, a block control driver to output a block control signal, a driving controller to control the gate emission, data, and block control drivers based on an input control signal, and a processor to output the input control signal, the pixel circuit including a driving transistor to generate a driving current based on a voltage of a first node, a block control transistor to connect first and second nodes in response to the block control signal, a write transistor to apply the data voltage to the second node in response to a write gate signal, a reset transistor to apply a reference voltage to the second node in response to a reset gate signal, and a light-emitting element to emit based on the driving current.

### CROSS-REFERENCE TO RELATED APPLICATION

The present application claims priority to, and the benefit of, Korean Patent Application No. 10-2024-0196747, filed on December 26, 2024, in the Korean Intellectual Property Office, the disclosure of which is incorporated herein by reference.

### BACKGROUND

1. Field

Embodiments of the present disclosure relate to an electronic device in which a power consumption is improved.

### 2. Description of the Related Art

Generally, a display device includes a display panel and a display panel driver. The display panel includes a plurality of gate lines, a plurality of data lines, a plurality of emission lines and a plurality of pixels. The display panel driver includes a gate driver providing a gate signal to the gate lines, a data driver providing a data voltage to the data lines, an emission driver providing an emission signal to the emission lines, and a driving controller controlling the gate driver, the data driver, and the emission driver.

When an image displayed on the display panel is a static image, or when the display panel is operated in always on mode, a driving frequency of the display panel may be decreased to reduce a power consumption.

### SUMMARY

Embodiments of the present disclosure provide an electronic device supporting a multiple division of a driving frequency to reduce a power consumption.

According to embodiments, an electronic device may include a display panel including a pixel circuit, a gate emission driver configured to output gate signals to the display panel, a data driver configured to apply data voltages to the display panel, a block control driver configured to output a block control signal to the display panel, a driving controller configured to control the gate emission driver, the data driver, and the block control driver based on an input control signal, and a processor configured to output the input control signal, wherein the pixel circuit includes a driving transistor configured to generate a driving current based on a voltage of a first node, a block control transistor configured to connect the first node and a second node in response to the block control signal, a write transistor configured to apply the data voltage to the second node in response to a write gate signal, a reset transistor configured to apply a reference voltage to the second node in response to a reset gate signal, and a light-emitting element configured to emit light based on the driving current.

A period in which the pixel circuit is driven may include an address period in which the light-emitting element is configured to emit light based on a data voltage of a present frame, and in which the block control signal has an activation level for turning on the block control transistor, and a self-scan period in which the light-emitting element is configured to emit light based on a data voltage of a previous frame.

The address period may include a first initialization period, a first write period, and a first emission period, wherein the reset gate signal and the block control signal have activation levels in the first initialization period, wherein the write gate signal and the block control signal have activation levels in the first write period, and wherein the block control transistor is configured to be turned on in the first initialization period and in the first write period.

The block control signal may have an inactivation level for turning off the block control transistor in the self-scan period following the address period.

The self-scan period may include a second initialization period, a second write period, and a second emission period, wherein the block control signal has an inactivation level in the second initialization period and the second write period.

The gate emission driver may further output a first emission signal and a second emission signal, wherein the pixel circuit further includes a first emission transistor configured to apply a first power voltage to the driving transistor in response to the first emission signal, and a second emission transistor configured to apply the driving current to the light-emitting element in response to the second emission signal.

The first emission transistor and the second emission transistor may include P-type transistors, and the driving transistor, the write transistor, the reset transistor, and the block control transistor may include N-type transistors.

The write transistor may include a control electrode for receiving the write gate signal, a first electrode for receiving the data voltage, and a second electrode connected to the second node, wherein the reset transistor includes a control electrode for receiving the reset gate signal, a first electrode for receiving the reference voltage, and a second electrode connected to the second node, and wherein the block control transistor includes a control electrode for receiving the block control signal, a first electrode connected to the second node, and a second electrode connected to the first node.

The gate emission driver may further output a first emission signal and a second emission signal, wherein the pixel circuit further includes a first emission transistor including a control electrode for receiving the first emission signal, a first electrode for receiving a first power voltage, and a second electrode connected to the driving transistor, and a second emission transistor including a control electrode for receiving the second emission signal, a first electrode connected to a third node, and a second electrode connected to a fourth node, wherein the driving transistor includes a control electrode connected to the first node, a first electrode connected to the second electrode of the first emission transistor, and a second electrode connected to the third node, and wherein the light-emitting element includes a first electrode connected to the fourth node, and a second electrode for receiving a second power voltage.

The pixel circuit may further include a light-emitting element initialization transistor including a control electrode for receiving an initialization gate signal, a first electrode for receiving an initialization voltage, and a second electrode connected to the fourth node.

The gate signals may be outputted to the pixel circuit through gate lines extending in a first direction, wherein the data voltage is applied to the pixel circuit through data lines extending in a second direction that is different from the first direction, and wherein the block control signal is outputted to the pixel circuit through block control lines extending in the second direction.

The display panel may include a first display region spaced apart from the gate emission driver in a first direction, and a second display region adjacent to the first display region in the first direction, wherein a driving frequency of the first display region is inconsistent with a driving frequency of the second display region.

The data driver may include a first region data driver for applying the data voltage to the first display region, and a second region data driver for applying the data voltage to the second display region, wherein a period in which the pixel circuit is driven includes an address period in which the light-emitting element is configured to emit light based on a data voltage of a present frame, and a self-scan period in which the light-emitting element is configured to emit light based on a data voltage of a previous frame, and wherein the first region data driver is configured to be turned off in the self-scan period.

The first region data driver may include an amplifying block, wherein a bias voltage is not applied to the amplifying block in the self-scan period.

According to embodiments, an electronic device may include a display panel including a pixel circuit, a display panel driver configured to drive the display panel based on an input control signal, and a processor configured to output the input control signal, wherein the pixel circuit includes a driving transistor configured to generate a driving current based on a voltage of a first node, a block control transistor configured to connect the first node and a second node in response to a block control signal, a write transistor configured to apply a data voltage to the second node in response to a write gate signal, a reset transistor configured to apply a reference voltage to the second node in response to a reset gate signal, and a light-emitting element configured to emit based on the driving current.

A period in which the pixel circuit is driven may include an address period in which the light-emitting element is configured to emit light based on a data voltage of a present frame, and a self-scan period in which the light-emitting element is configured to emit light based on a data voltage of a previous frame, wherein the block control signal has an activation level for turning on the block control transistor in the address period.

The address period may include a first initialization period, a first write period, and a first emission period, wherein the reset gate signal and the block control signal have activation levels in the first initialization period, wherein the write gate signal and the block control signal have activation levels in the first write period, and wherein the block control transistor is configured to be turned on in the first initialization period and the first write period.

The block control signal may have an inactivation level for turning off the block control transistor in the self-scan period following the address period.

The self-scan period may include a second initialization period, a second write period, and a second emission period, wherein the block control signal has an inactivation level in the second initialization period and in the second write period.

The write transistor may include a control electrode for receiving the write gate signal, a first electrode for receiving the data voltage, and a second electrode connected to the second node, wherein the reset transistor includes a control electrode for receiving the reset gate signal, a first electrode for receiving the reference voltage, and a second electrode connected to the second node, and wherein the block control transistor includes a control electrode for receiving the block control signal, a first electrode connected to the second node, and a second electrode connected to the first node.

As described above, a writing operation and an initialization operation of a pixel circuit may be controlled based on a block control signal. Accordingly, a display device may apply a multiple division of a driving frequency.

Additionally, through the multiple division of a driving frequency, a power consumption of a display device may be effectively reduced.

Additionally, when the display panel may be driven as a horizontal multiple division of the driving frequency, the first region data driver, the second region data driver, and/or the third region data driver may be turned off. Accordingly, a power consumption of the display device may be further reduced.

Additionally, when the display panel may be driven as a horizontal multiple division of the driving frequency, the amplifying block included in the first region data driver, the second region data driver, and/or the third region data driver may be turned off. Accordingly, a power consumption of the display device 1 may be further reduced.

Additionally, when the display panel may be driven as a horizontal multiple division of the driving frequency, the high data power voltage may not be applied to the first region data driver, the second region data driver, and/or the third region data driver. Accordingly, a power consumption of the display device 1 may be further reduced.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the present disclosure.

FIG. 2 is a block diagram illustrating a display panel, a gate emission driver, a data driver, and a block control driver of FIG. 1.

FIG. 3 is a conceptual diagram illustrating a block control signal outputted from a block control driver of FIG. 1 according to driving frequencies of portions of the display panel of FIG. 1.

FIG. 4 is a circuit diagram illustrating an example of a pixel circuit of FIG. 1.

FIG. 5 is a timing diagram illustrating signals applied to a pixel circuit of FIG. 4.

FIG. 6 is a timing diagram illustrating signals applied to a pixel circuit in an address period of FIG. 5.

FIG. 7 is a circuit diagram illustrating an operation of a pixel circuit in a first period of FIG. 6.

FIG. 8 is a circuit diagram illustrating an operation of a pixel circuit in a second period of FIG. 6.

FIG. 9 is a circuit diagram illustrating an operation of a pixel circuit in a third period of FIG. 6.

FIG. 10 is a circuit diagram illustrating an operation of a pixel circuit in a fourth period of FIG. 6.

FIG. 11 is a circuit diagram illustrating an operation of a pixel circuit in a fifth period of FIG. 6.

FIG. 12 is a timing diagram illustrating signals applied to a pixel circuit in a self-scan period of FIG. 5.

FIG. 13 is a circuit diagram illustrating an operation of a pixel circuit in a first period of FIG. 12.

FIG. 14 is a circuit diagram illustrating an operation of a pixel circuit in a second period of FIG. 12.

FIG. 15 is a circuit diagram illustrating an operation of a pixel circuit in a third period of FIG. 12.

FIG. 16 is a circuit diagram illustrating an operation of a pixel circuit in a fourth period of FIG. 12.

FIG. 17 is a circuit diagram illustrating an operation of a pixel circuit in a fifth period of FIG. 12.

FIG. 18 is a timing diagram illustrating signals applied to a pixel circuit of FIG. 4.

FIG. 19 is a timing diagram illustrating signals applied to a pixel circuit in a self-scan period of FIG. 18.

FIG. 20 is a circuit diagram illustrating an operation of a pixel circuit in a first period of FIG. 19.

FIG. 21 is a circuit diagram illustrating an operation of a pixel circuit in a second period of FIG. 19.

FIG. 22 is a circuit diagram illustrating an operation of a pixel circuit in a third period of FIG. 19.

FIG. 23 is a circuit diagram illustrating an operation of a pixel circuit in a fourth period of FIG. 19.

FIG. 24 is a circuit diagram illustrating an operation of a pixel circuit in a fifth period of FIG. 19.

FIG. 25 is a block diagram illustrating an example of a data driver of FIG. 1 and a display panel of FIG. 1.

FIG. 26 is a block diagram illustrating an example of the first region data driver, the second region data driver, and/or the third region data driver of FIG. 25.

FIG. 27 is a circuit diagram illustrating an example of a pixel circuit of FIG. 1.

FIG. 28 is a timing diagram illustrating signals applied to a pixel circuit of FIG. 27.

FIG. 29 is a circuit diagram illustrating an example of a pixel circuit of FIG. 1.

FIG. 30 is a timing diagram illustrating signals applied to a pixel circuit of FIG. 29.

FIG. 31 is a conceptual diagram illustrating a block control signal outputted from a block control driver of FIG. 1 according to driving frequencies of portions of the display panel of FIG. 1.

FIG. 32 is a block diagram illustrating an example of a data driver of FIG. 1 and a display panel of FIG. 1.

FIG. 33 is a block diagram illustrating an example of a data driver of FIG. 1 and a display panel of FIG. 1.

FIG. 34 is a block diagram illustrating an electronic device according to one or more embodiments of the present disclosure.

FIG. 35 is a diagram illustrating an example in which the electronic device of FIG. 34 is implemented as a smart phone.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When "C to D" is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer, or section described below could be termed a second element, component, region, layer, or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/- 5 % of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ± 30%, 20%, 10%, 5% of the stated value. Further, the use of “may” when describing embodiments of the present disclosure refers to “one or more embodiments of the present disclosure.” Furthermore, the expression “being the same” may mean “being substantially the same.” In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

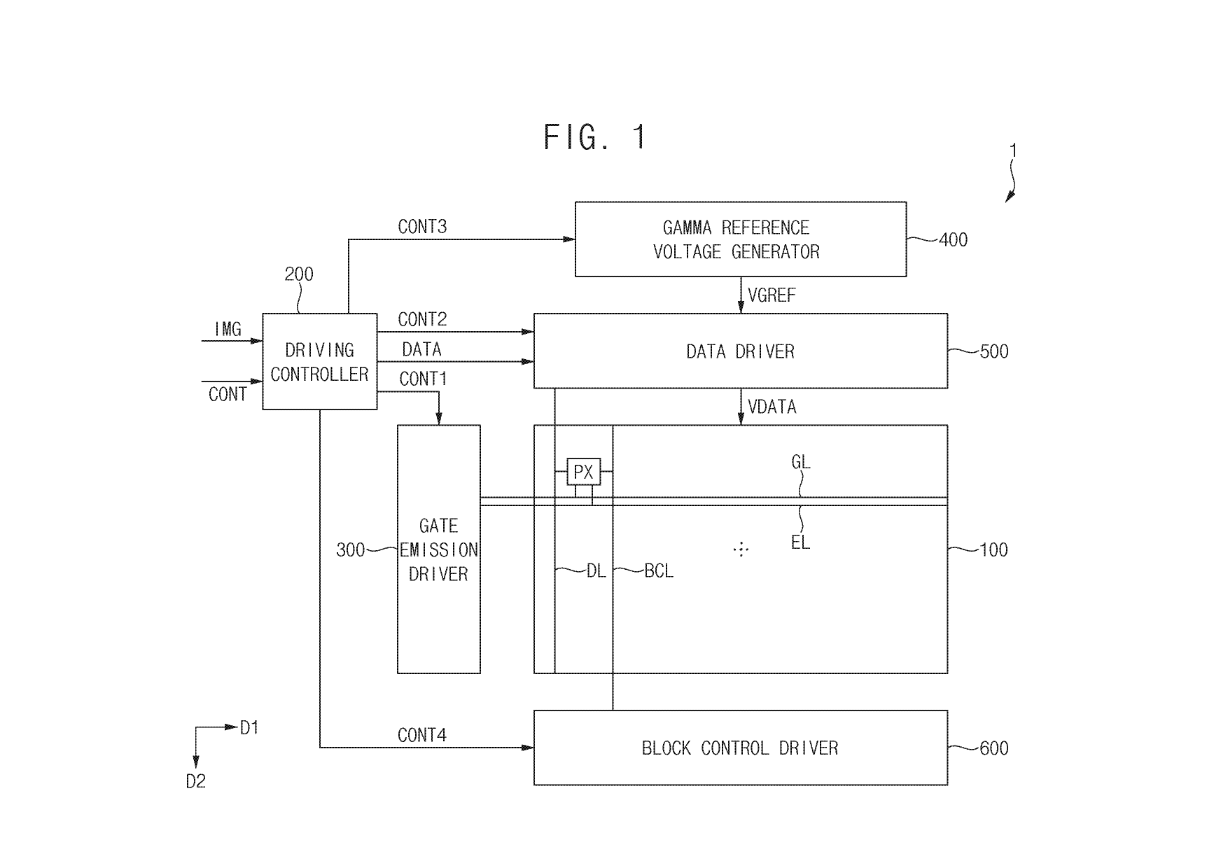

FIG. 1 is a block diagram illustrating a display device 1 according to embodiments of the present disclosure.

Referring to FIG. 1, the display device 1 may include a display panel 100 and a display panel driver. The display panel driver may include a driving controller 200, a gate emission driver 300, a gamma reference voltage generator 400, a data driver 500, and block control driver 600.

The display panel 100 may have a display region on which an image is displayed, and a peripheral region adjacent to the display region.

The display panel 100 may include a plurality of gate lines GL, a plurality of data lines DL, a plurality of emission lines EL, a plurality of block control lines BCL, and a plurality of pixel circuits PX electrically connected to the gate lines GL, the data lines DL, the emission lines EL, and the block control lines BCL. The gate lines GL may extend in a first direction D1. The data lines DL may extend in a second direction D2 crossing the first direction D1. The emission lines EL may extend in the first direction D1. The block control lines BCL may extend in the second direction D2.

The driving controller 200 may receive input image data IMG and an input control signal CONT from an external apparatus. For example, the input image data IMG may include red image data, green image data, and blue image data. The input image data IMG may include white image data. The input image data IMG may include magenta image data, cyan image data, and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, and a data signal DATA based on the input image data IMG and the input control signal CONT.

The driving controller 200 may generate the first control signal CONT1 for controlling an operation of the gate emission driver 300 based on the input control signal CONT, and may output the first control signal CONT1 to the gate emission driver 300. The first control signal CONT1 may include a vertical start signal and a gate clock signal.

The driving controller 200 may generate the second control signal CONT2 for controlling an operation of the data driver 500 based on the input control signal CONT, and may output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and may output the third control signal CONT3 to the gamma reference voltage generator 400.

The driving controller 200 may generate the fourth control signal CONT4 for controlling an operation of the block control driver 600 based on the input control signal CONT, and may output the fourth control signal CONT4 to the block control driver 600.

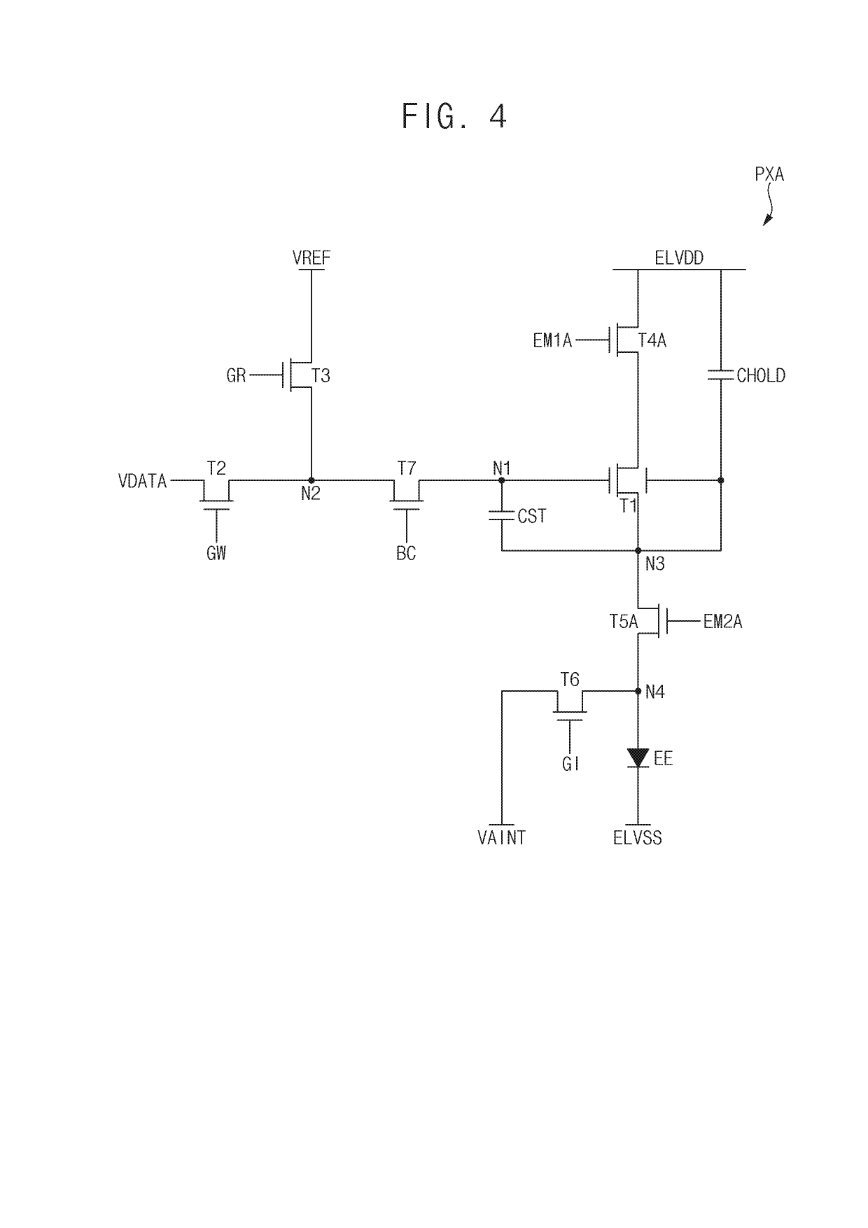

The gate emission driver 300 may generate gate signals driving the gate lines GL in response to the first control signal CONT1 received from the driving controller 200. The gate emission driver 300 may generate a first emission signal and a second emission signal driving the emission lines EL in response to the first control signal CONT1 received from the driving controller 200. The gate emission driver 300 may output the gate signals to the gate lines GL. For example, the gate signals may include an initialization gate signal GI of FIG. 4, a write gate signal GW of FIG. 4, and a reset gate signal GR of FIG. 4.

An activation level of the gate signal may be a voltage level such that a transistor is turned on. An inactivation level of the gate signal may be a voltage level such that a transistor is turned off. An activation level of the emission signal may be a voltage level such that a transistor is turned on. An inactivation level of the emission signal may be a voltage level such that a transistor is turned off.

In one or more embodiments, each of activation levels of the initialization gate signal GI of FIG. 4, the write gate signal GW of FIG. 4, the reset gate signal GR of FIG. 4, the first emission signal, and the second emission signal may be same. In one or more embodiments, each of inactivation levels of the initialization gate signal GI of FIG. 4, the write gate signal GW of FIG. 4, the reset gate signal GR of FIG. 4, the first emission signal, and the second emission signal may be same.

In one or more embodiments, each of activation levels of the initialization gate signal GI of FIG. 4, the write gate signal GW of FIG. 4, the reset gate signal GR of FIG. 4, the first emission signal, and the second emission signal may be different. In one or more embodiments, each of inactivation levels of the initialization gate signal GI of FIG. 4, the write gate signal GW of FIG. 4, the reset gate signal GR of FIG. 4, the first emission signal, and the second emission signal may be different.

In one or more embodiments, the gate emission driver 300 may be integrated in the peripheral region. In one or more embodiments, the gate emission driver 300 may be located in the peripheral region.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA.

In one or more embodiments, the gamma reference voltage generator 400 may be located in the driving controller 200, or in the data driver 500.

The data driver 500 may receive the second control signal CONT2 and the data signal DATA from the driving controller 200, and may receive the gamma reference voltages VGREF from the gamma reference voltage generator 400. The data driver 500 may convert the data signal DATA into data voltages having an analog type using the gamma reference voltages VGREF. The data driver 500 may output the data voltages to the data lines DL. In one or more embodiments, the data driver 500 may receive a block-driving control signal from the driving controller 200. In one or more embodiments, the second control signal CONT2 may include the block-driving control signal.

In one or more embodiments, the data driver 500 may be integrated in the peripheral region. In one or more embodiments, the data driver 500 may be located in the peripheral region.

The block control driver 600 may generate a block control signal BC of FIG. 4 in response to the first control signal CONT1 received from the driving controller 200. The block control driver 600 may output the block control signal BC of FIG. 4 to the display panel. In one or more embodiments, the fourth control signal CONT4 may include the block-driving control signal.

In one or more embodiments, the block control driver 600 may be integrated in the peripheral region. In one or more embodiments, the block control driver 600 may be located in the peripheral region.

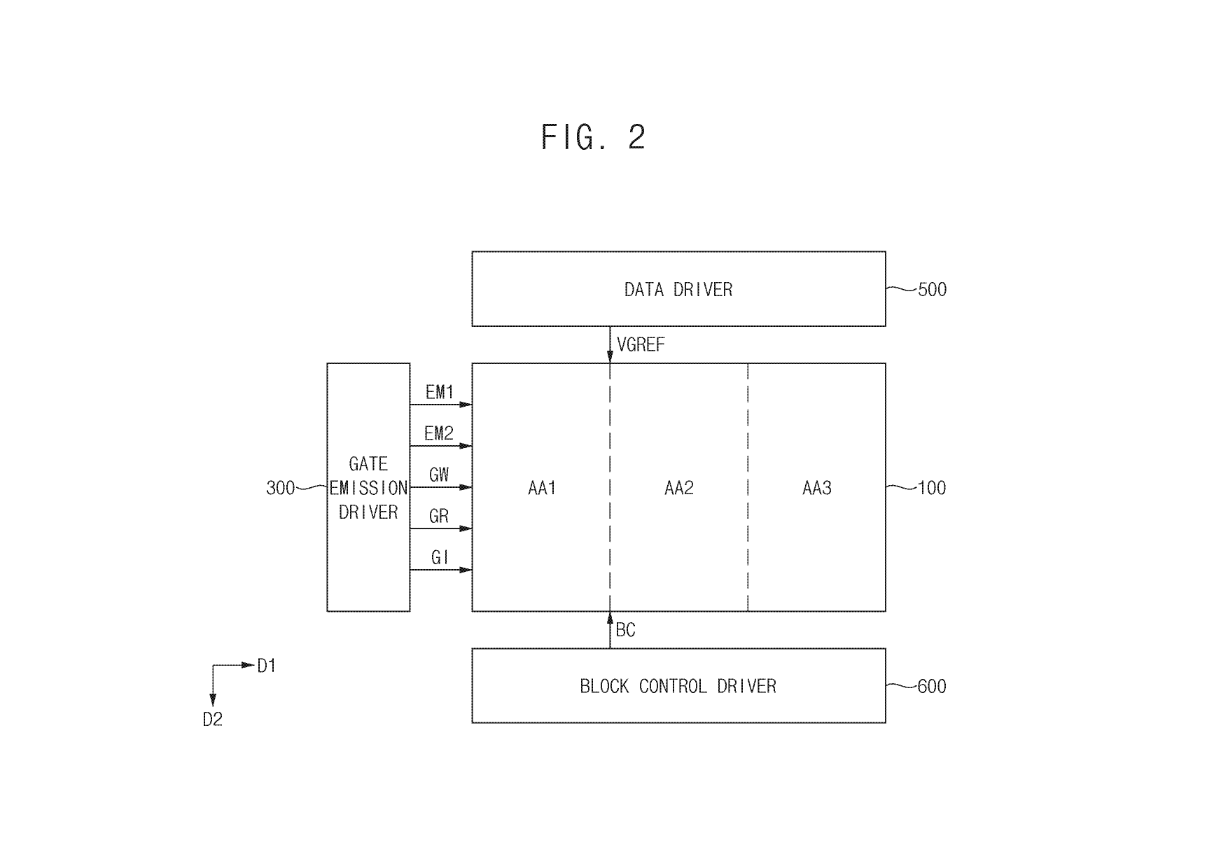

FIG. 2 is a block diagram illustrating a display panel 100, a gate emission driver 300, a data driver 500, and a block control driver 600 of FIG. 1.

Referring to FIG. 1 and FIG. 2, the display panel 100 may include a first display region AA1, a second display region AA2, and a third display region AA3. For example, the display region may include the first display region AA1, the second display region AA2, and the third display region AA3.

The first display region AA1 may be located spaced apart from the gate emission driver 300 in the first direction D1. The second display region AA2 may be located adjacent to the first display region AA1 in the first direction D1. The third display region AA3 may be located adjacent to the second display region AA2 in the first direction D1. A driving frequency of the first display region AA1, a driving frequency of the second display region AA2, and a driving frequency of the third

display region AA3 may be different from each other. For example, the first display region AA1 may emit as a first driving frequency. For example, the second display region AA2 may emit as the first driving frequency. For example, the second display region AA2 may emit as a second driving frequency that is different from the first driving frequency. For example, the first driving frequency may be about 1Hz. For example, the second driving frequency may be about 120Hz. However, the present disclosure is not limited to a value of the driving frequency.

The driving frequency of the first display region AA1 may be inconsistent with the driving frequency of the second display region AA2, so that the display panel 100 may support the multiple division of the driving frequency. The display panel 100 may support the multiple division of the driving frequency, so that a power consumption of the display device 1 may be reduced. For example, display panel 100 may support the horizontal multiple division of the driving frequency.

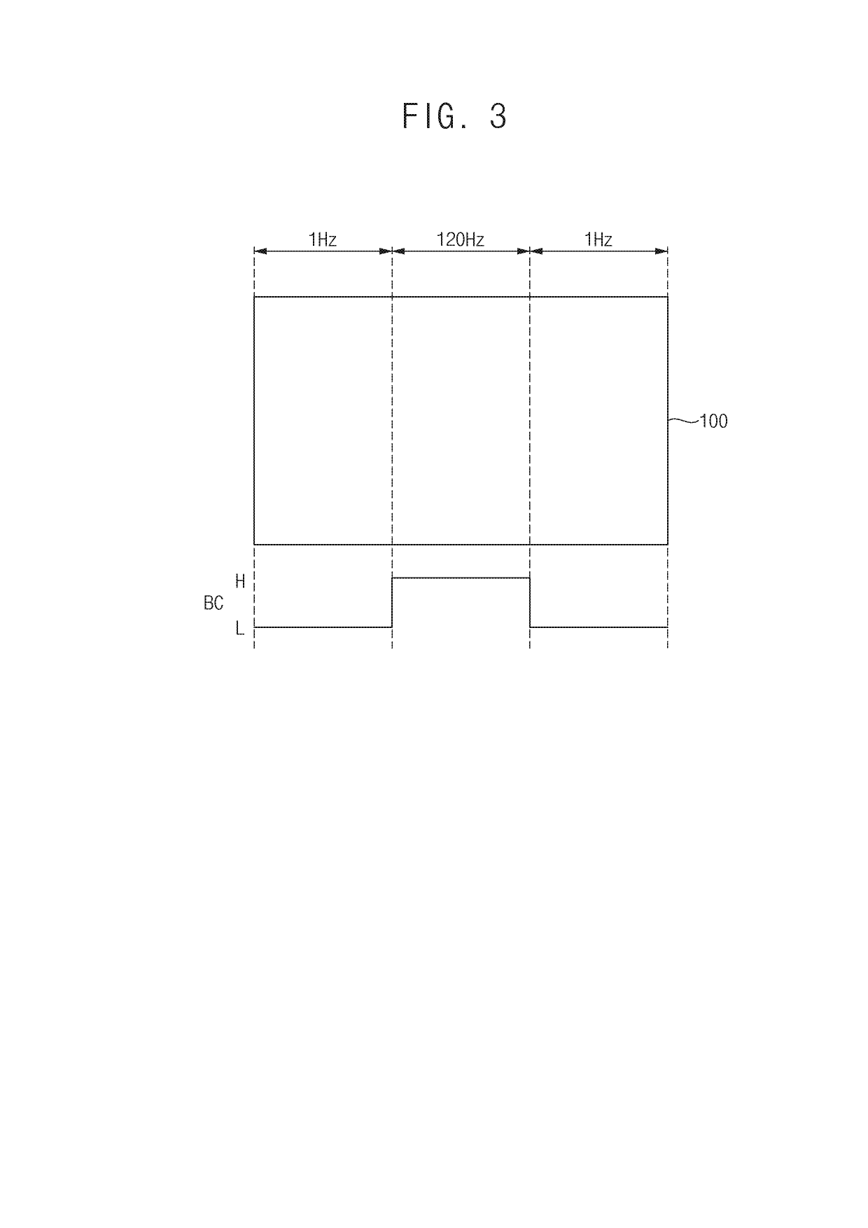

FIG. 3 is a conceptual diagram illustrating a block control signal BC outputted from a block control driver 600 of FIG. 1 according to driving frequencies of portions of the display panel 100 of FIG. 1. FIG. 4 is a circuit diagram illustrating an example of a pixel circuit PX of FIG. 1.

Referring to FIG. 1 to FIG. 4, the pixel circuit PXA may include a first transistor T1, a second transistor T2, a third transistor T3A, a fourth transistor T4A, a fifth transistor T5A, a sixth transistor T6, a seventh transistor T7, a storage capacitor CST, a hold capacitor CHOLD, and a light-emitting element EE.

The first transistor T1 may include a control electrode connected to the first node N1, a first electrode connected to the fourth transistor T4, and a second electrode connected to a third node N3. The first transistor T1 may generate a driving current based on a voltage of the first node N1. For example, the first transistor T1 may be called as a driving transistor. In one or more embodiments, the first transistor T1 may further include a second control electrode connected to the third node N3.

The second transistor T2 may include a control electrode for receiving the write gate signal GW, a first electrode for receiving the data voltage VDATA, and a second electrode connected to a second node N2. The second transistor T2 may apply the data voltage VDATA to the second node N2 in response to the write gate signal GW. For example, an operation in which the data voltage VDATA is applied to the first node N1 may be called as a write operation. For example, an operation in which the data voltage VDATA is applied to the control electrode of the first transistor T1 may be called as the write operation. For example, the second transistor T2 may be called as a write transistor.

The third transistor T3 may include a control electrode for receiving the reset gate signal GR, a first electrode for receiving the reference voltage VREF, and a second electrode connected to the second node N2. The third transistor T3 may apply the reference voltage VREF to the second node N2 in response to the reset gate signal GR. For example, an operation in which the reference voltage VREF is applied to the first node N1 may be called as a reset operation. For example, the reset operation may be called as an initialization operation. For example, the third transistor T3 may be called as a reset transistor.

The fourth transistor T4A may include a control electrode for receiving a first emission signal EM1A, a first electrode for receiving a first power voltage ELVDD, and a second electrode connected to the first transistor T1. The fourth transistor T4A may apply the first power voltage ELVDD to the first transistor T1 in response to the first emission signal EM1A. For example, the fourth transistor T4A may be called as a first emission transistor.

The fifth transistor T5A may include a control electrode for receiving a second emission signal EM2A, a first electrode connected to the third node N3, and a second electrode connected to the fourth node N4. The fifth transistor T5A may connect the third node N3 and a fourth node N4 in response to the second emission signal EM2A. For example, the fifth transistor T5A may called as a second emission transistor.

The sixth transistor T6 may include a control electrode for receiving the initialization gate signal GI, a first electrode for receiving an initialization voltage VAINT, and a second electrode connected to the fourth node N4. The sixth transistor T6 may apply the initialization voltage VAINT to the fourth node N4 in response to the initialization gate signal GI. For example, the sixth transistor T6 may be called as a light-emitting element initialization transistor. In one or more embodiments, the initialization voltage VAINT may be lower than a second power voltage ELVSS. The initialization voltage VAINT may be lower than a second power voltage ELVSS, so that a black characteristic of the light-emitting element EE may be improved.

The seventh transistor T7 may include a control electrode for receiving the block control signal BC, a first electrode connected to the second node N2, and a second electrode connected to the first node N1. The seventh transistor T7 may connect the second node N2 and the first node N1 in response to the block control signal BC. For example, the seventh transistor T7 may be called as a block control transistor.

The storage capacitor CST may include a first electrode connected to the first node N1, and a second electrode connected to the third node N3.

The hold capacitor CHOLD may include a first electrode for receiving the first power voltage ELVDD, and a second electrode connected to the third node N3.

The light-emitting element EE may include a first electrode connected to the fourth node N4, and a second electrode for receiving the second power voltage ELVSS. The light-emitting element EE may emit light based on the driving current.

For example, when the block control signal BC has an activation level, the seventh transistor T7 may be turned on. The activation level of the block control signal BC may be a high level H.

For example, when the block control signal BC has an inactivation level, the seventh transistor T7 may be turned off. The inactivation level of the block control signal BC may be a low level L.

The pixel circuit PXA may emit light as a high frequency (e.g., 120 Hz) for a region within the display panel 100 that requires high-frequency driving, and may emit light as a low frequency (e.g., 1 Hz) for a region within the display panel 100 that requires low-frequency driving, based on a block control signal BC.

For example, when the display panel 100 emits as the high frequency, the block control signal BC may have an activation level. The block control signal BC may have an activation level, so that the seventh transistor T7 may be turned on. The seventh transistor T7 may be turned on, so that the second node N2 and the first node N1 may be connected. The second node N2 and the first node N1 may be connected, so that the first node N1 may be initialized as a reference voltage. Additionally, the data voltage VDATA may be applied to the first node N1. Accordingly, the pixel circuit PXA may emit as a data voltage of a present frame.

For example, when the display panel 100 emits as the low frequency, the block control signal BC may have an inactivation level. The block control signal BC may have an inactivation level, so that the seventh transistor T7 may be turned off. The seventh transistor T7 may be turned off, so that the second node N2 and the first node N1 may not be connected. The second node N2 and the first node N1 may not be connected, so that the first node N1 may not be changed. Accordingly, the pixel circuit PXA may emit as a data voltage of a previous frame.

The first to seventh transistors T1, T2, T3, T4A, T5A, T6, T7 may be N-type transistors. However, the present disclosure is not limited to a type of transistors. For example, the present disclosure may apply to pixel including only P-type transistors. For example, some transistors of pixel circuit may be P-type transistors. For example, some transistors of a pixel circuit may be P-type transistors, and other transistors of a pixel circuit may be N-type transistors.

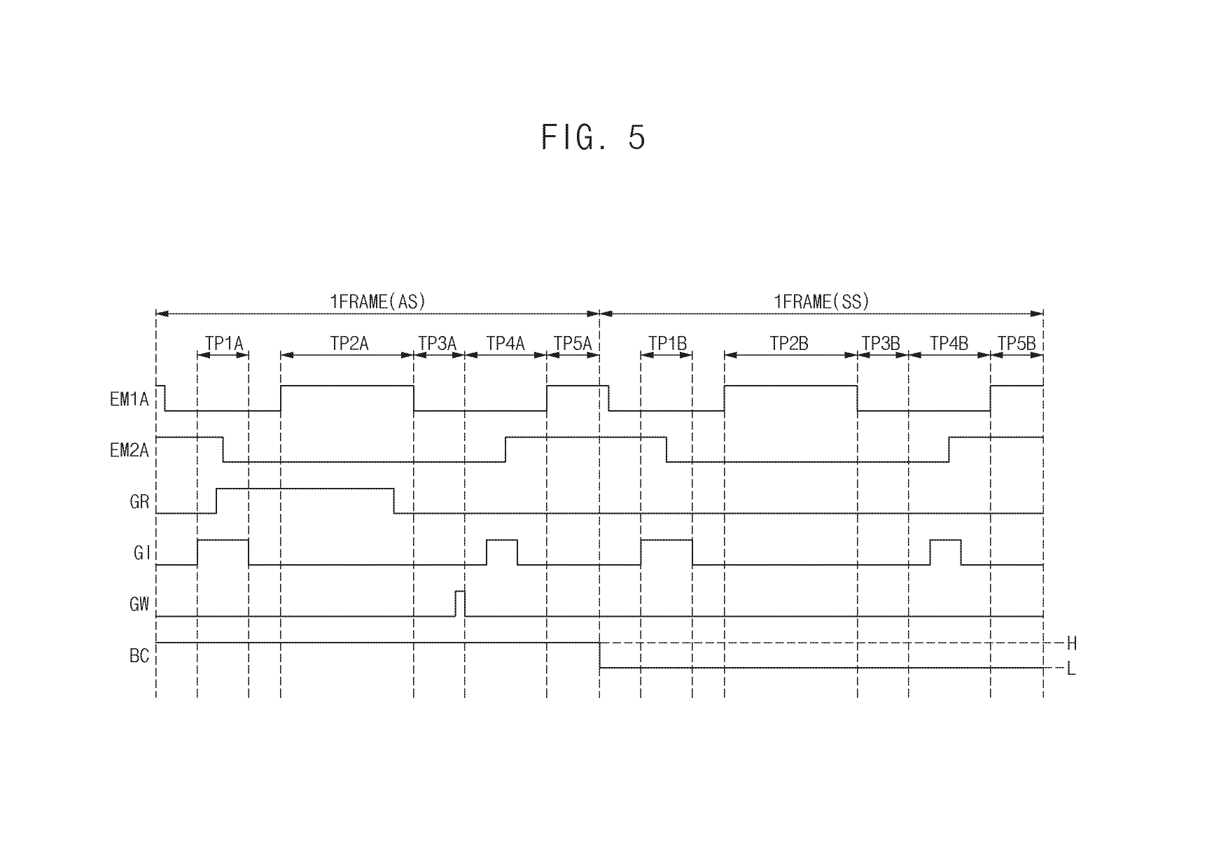

FIG. 5 is a timing diagram illustrating signals applied to a pixel circuit PXA of FIG. 4.

Referring to FIG. 1 to FIG. 5, a period in which the pixel circuit PXA is driven may include an address period AS and a self-scan period SS.

In the address period AS, the reset operation and a writing operation may be performed. In the address period AS, the pixel circuit PXA may emit based on a data voltage of the present frame. In the self-scan period SS, the reset operation and the writing operation may not be performed. In the self-scan period SS, the pixel circuit PXA may emit based on a data voltage of the previous frame.

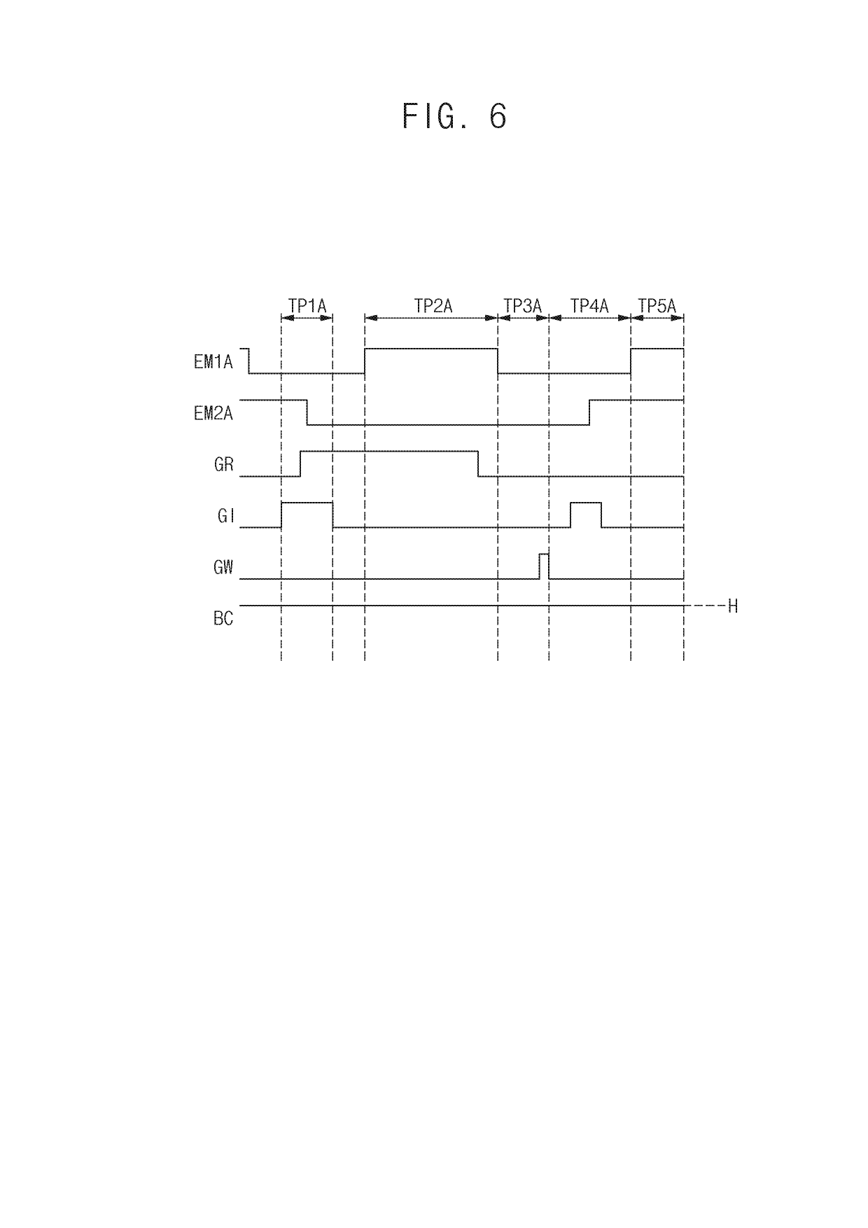

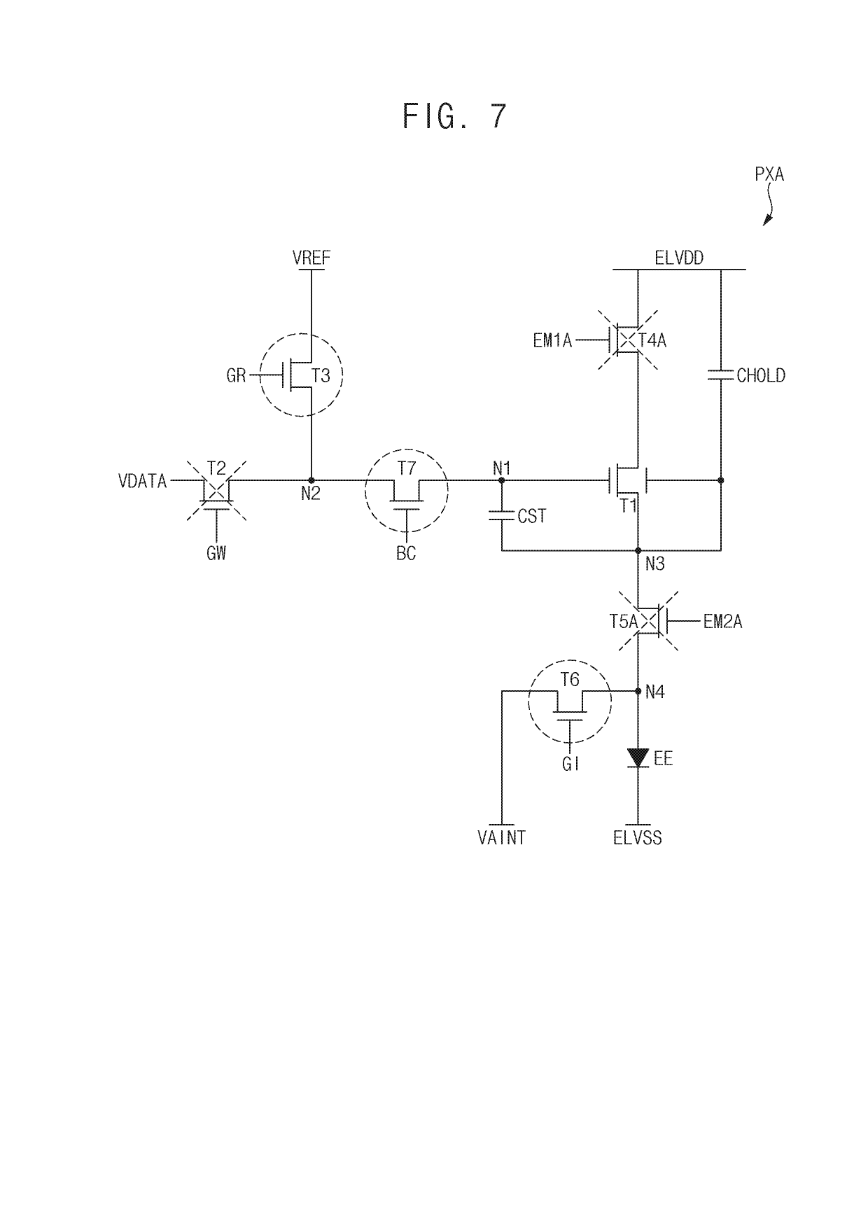

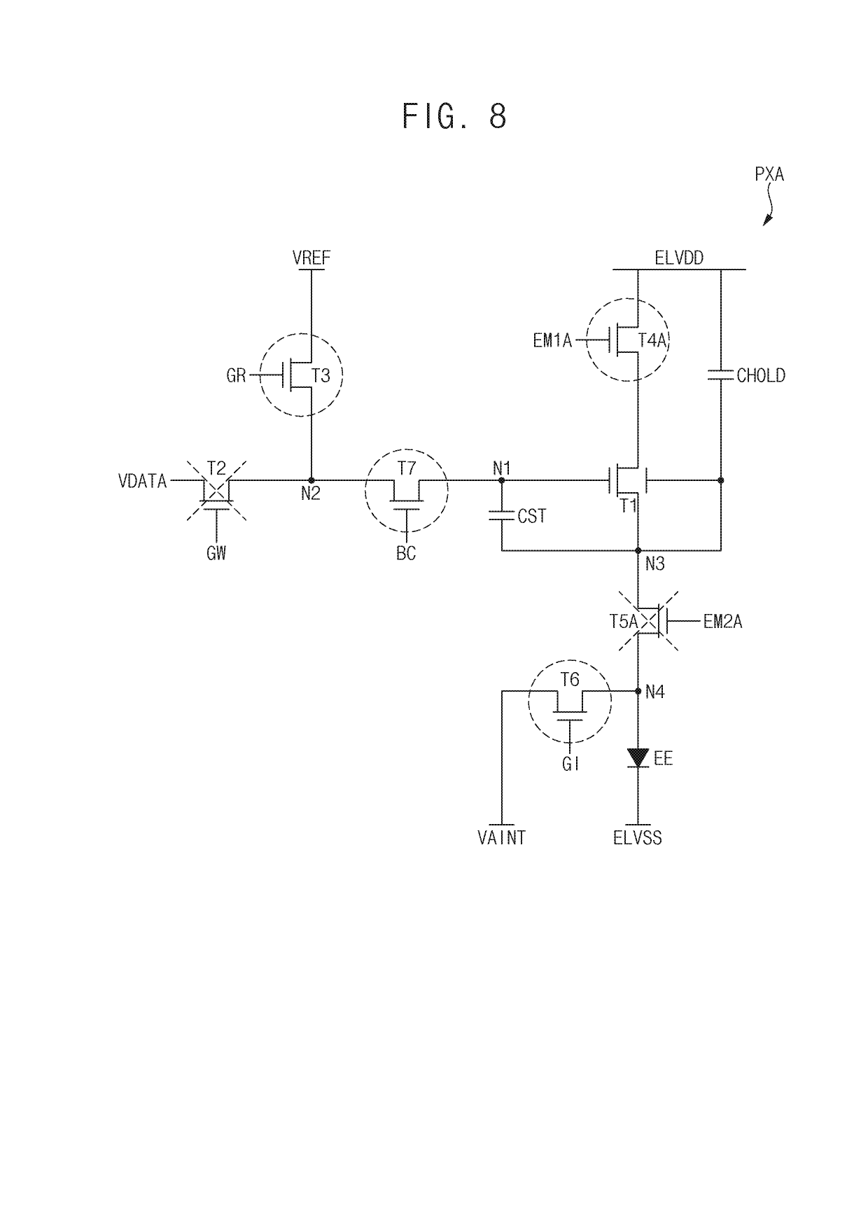

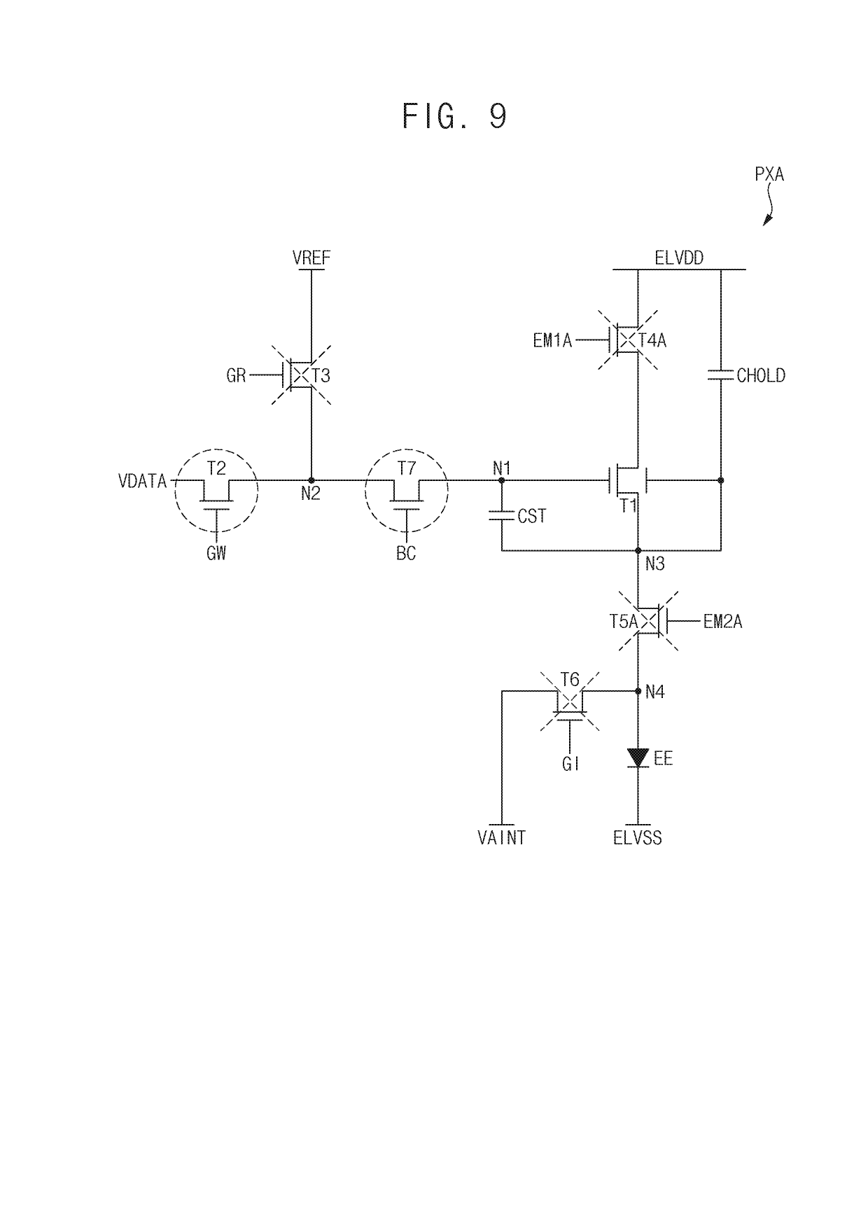

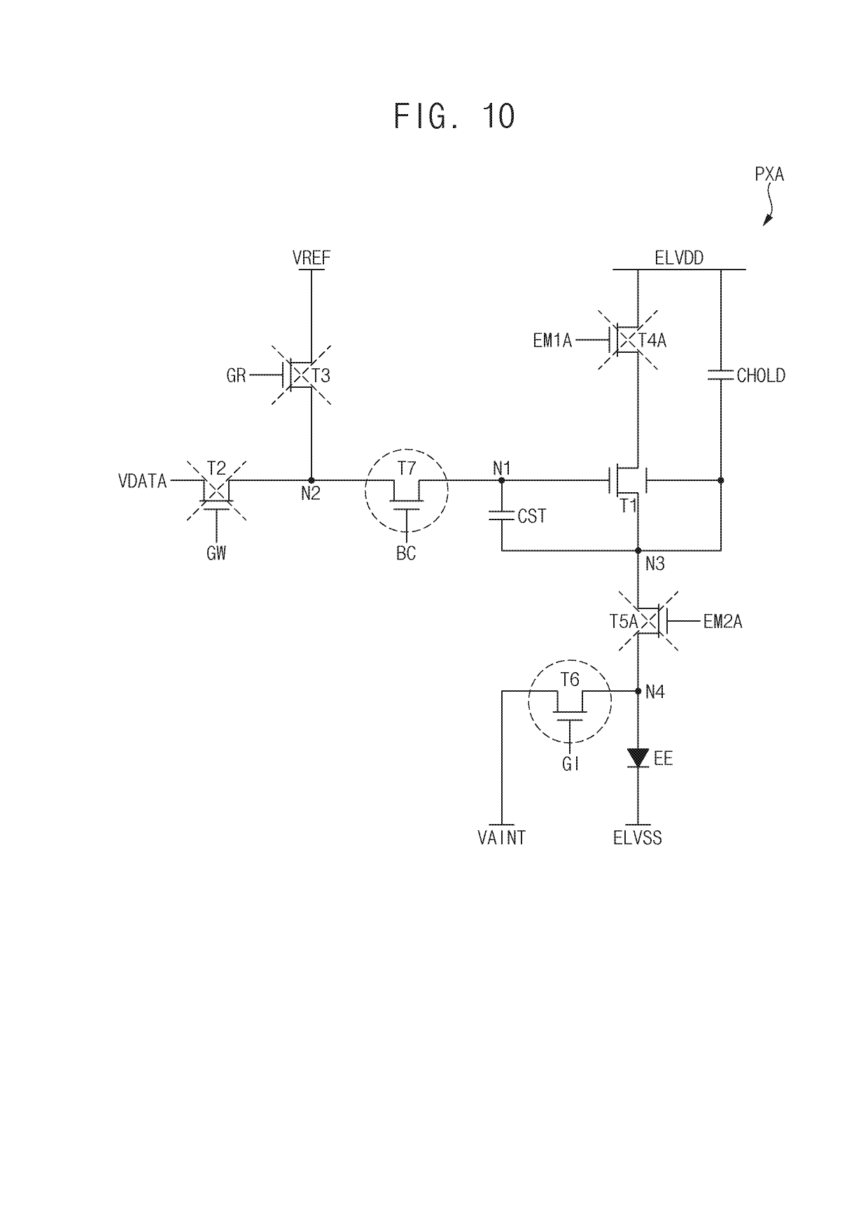

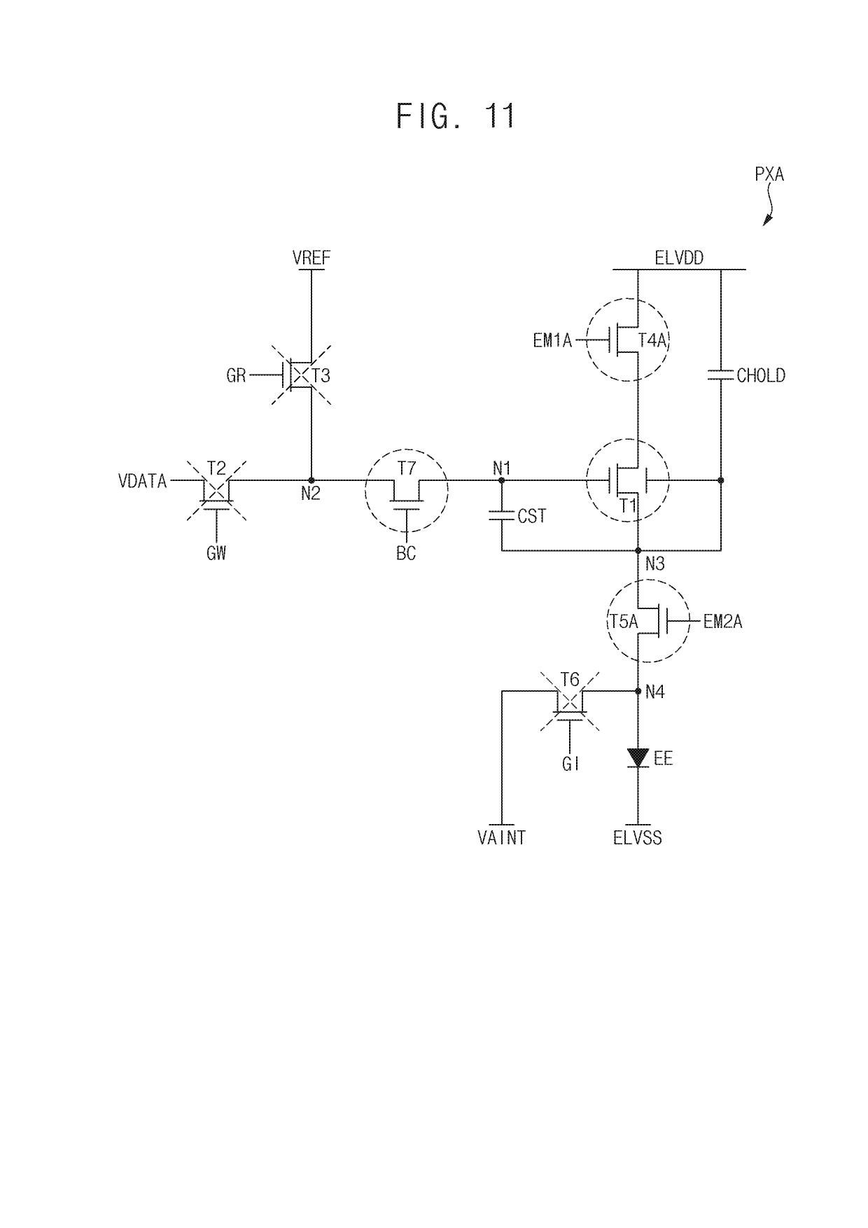

FIG. 6 is a timing diagram illustrating signals applied to a pixel circuit PXA in an address period AS of FIG. 5. FIG. 7 is a circuit diagram illustrating an operation of a pixel circuit PXA in a first period TP1A of FIG. 6. FIG. 8 is a circuit diagram illustrating an operation of a pixel circuit PXA in a second period TP2A of FIG. 6. FIG. 9 is a circuit diagram illustrating an operation of a pixel circuit PXA in a third period TP3A of FIG. 6. FIG. 10 is a circuit diagram illustrating an operation of a pixel circuit PXA in a fourth period TP4A of FIG. 6. FIG. 11 is a circuit diagram illustrating an operation of a pixel circuit PXA in a fifth period TP5A of FIG. 6.

Referring to FIG. 1 to FIG. 11, the address period AS may include a first period TP1A, a second period TP2A, a third period TP3A, a fourth period TP4A, and a fifth period TP5A.

In the first period TP1A, the first emission signal EM1A may have an inactivation level, the second emission signal EM2A may have an inactivation level, the reset gate signal GR may have an activation level, the initialization gate signal GI may have an activation level, the write gate signal GW may have an inactivation level, and the block control signal BC may have an activation level.

In the first period TP1A, the third transistor T3 may be turned on in response to the reset gate signal GR. In the first period TP1A, the seventh transistor T7 may be turned on in response to the block control signal BC. The third transistor T3 and the seventh transistor T7 may be turned on, so that the reference voltage VREF may be applied to the first node N1. Accordingly, the first node N1 may be initialized as the reference voltage VREF. In the first period TP1A, the fourth transistor T4A may be turned off in response to the first emission signal EM1A. In the first period TP1A, the fifth transistor T5A may be turned off in response to the second emission signal EM2A. In the first period TP1A, the sixth transistor T6 may be turned on in response to the initialization gate signal GI. The sixth transistor T6 may be turned on, so that the initialization voltage VAINT may be applied to the fourth node N4. In the first period TP1A, the light-emitting element EE may stop emitting. For example, the first period TP1A may be called as a first initialization period.

In the second period TP2A, the first emission signal EM1A may have an activation level, the second emission signal EM2A may have an inactivation level, the reset gate signal GR may have an activation level, the initialization gate signal GI may have an inactivation level, the write gate signal GW may have an inactivation level, and the block control signal BC may have an activation level.

In the second period TP2A, the fourth transistor T4A may be turned on in response to the first emission signal EM1A. The fourth transistor T4A may be turned on, so that the first power voltage ELVDD may be applied to the first transistor T1. For example, the second period TP2A may be called as a first compensation period.

In the third period TP3A, the first emission signal EM1A may have an inactivation level, the second emission signal EM2A may have an inactivation level, the reset gate signal GR may have an inactivation level, the initialization gate signal GI may have an inactivation level, the write gate signal GW may have an activation level, and the block control signal BC may have an activation level.

In the third period TP3A, the third transistor T3 may be turned off in response to the reset gate signal GR. In the third period TP3A, the second transistor T2 may be turned on in response to the write gate signal GW. In the third period TP3A, the seventh transistor T7 may be turned on in response to the block control signal BC. The second transistor T2 and the seventh transistor T7 may be turned on, so that the data voltage VDATA may be applied to the first node N1. For example, the third period TP3A may be called as a first write period.

In the fourth period TP4A, the first emission signal EM1A may have an inactivation level, the second emission signal EM2A may have an inactivation level, the reset gate signal GR may have an inactivation level, the initialization gate signal GI may have an activation level, the write gate signal GW may have an inactivation level, and the block control signal BC may have an activation level.

In the fourth period TP4A, the second transistor T2 may be turned off in response to the write gate signal GW. In the fourth period TP4A, the sixth transistor T6 may be turned on in response to the initialization gate signal GI. For example, the fourth period TP4A may be called as a first emission waiting period.

In the fifth period TP5A, the first emission signal EM1A may have an activation level, the second emission signal EM2A may have an activation level, the reset gate signal GR may have an inactivation level, the initialization gate signal GI may have an inactivation level, the write gate signal GW may have an inactivation level, and the block control signal BC may have an activation level.

In the fifth period TP5A, the fourth transistor T4A may be turned on in response to the first emission signal EM1A. In the fifth period TP5A, the fifth transistor T5A may be turned on in response to the second emission signal EM2A. In the fifth period TP5A, the sixth transistor T6 may be turned off in response to the initialization gate signal GI. The first transistor T1, the fourth transistor T4A and the fifth transistor T5A may be turned on, so that the driving current may be applied to the light-emitting element EE. Accordingly, the light-emitting element EE may emit light based on the driving current. For example, the fifth period TP5A may be called as a first emission period.

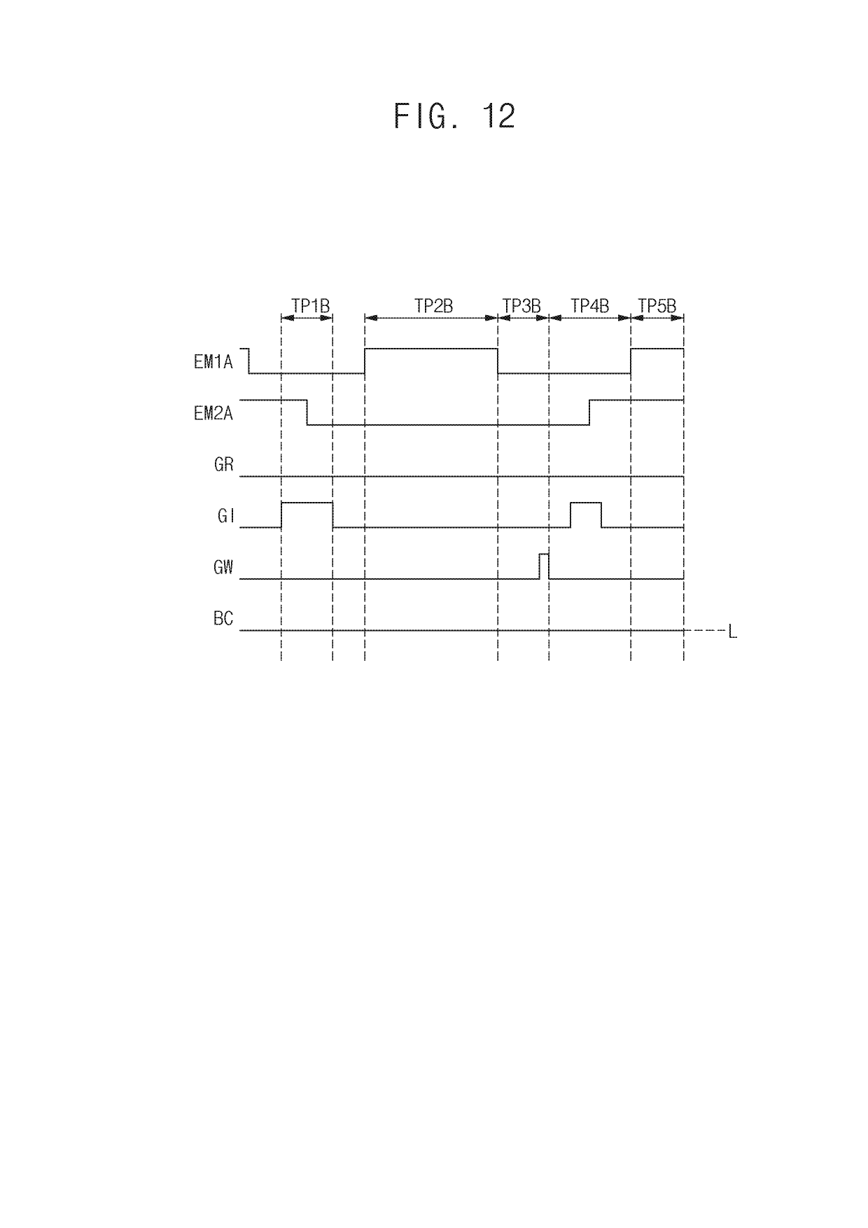

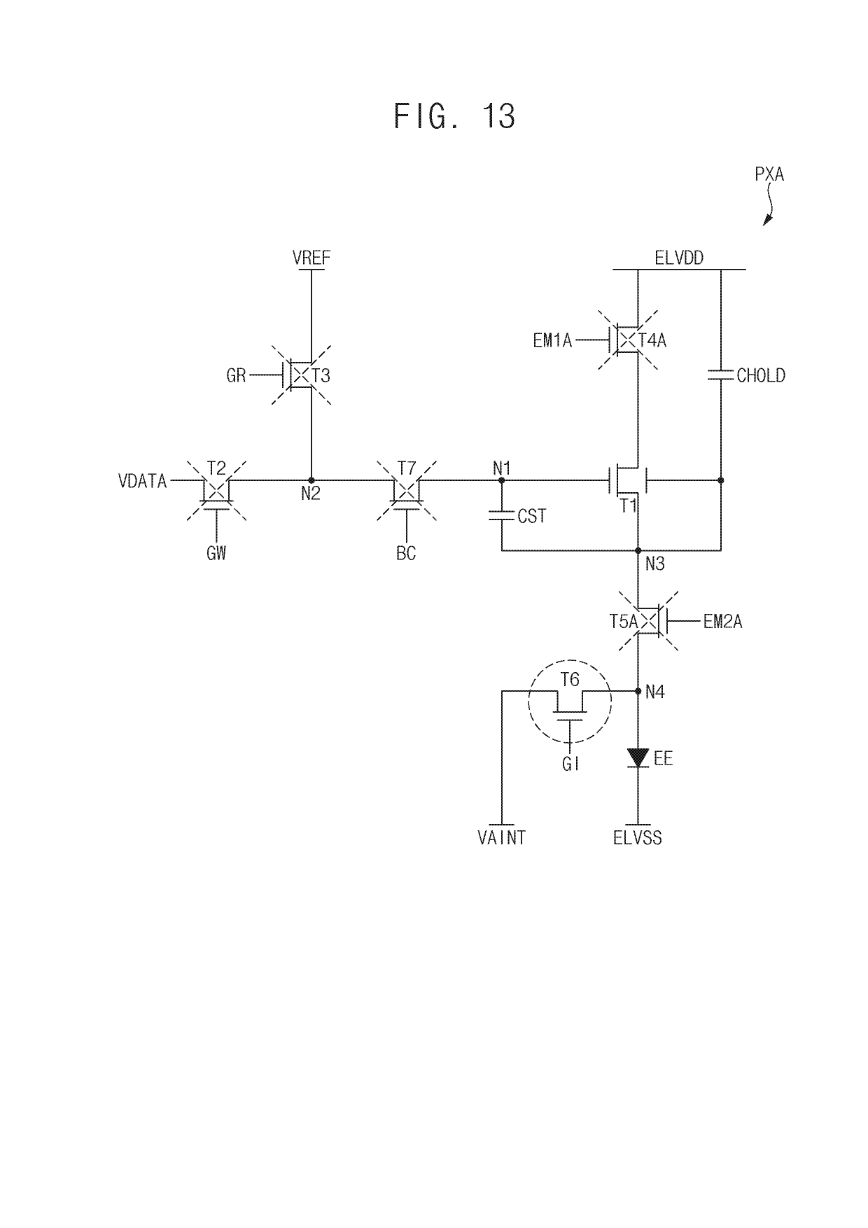

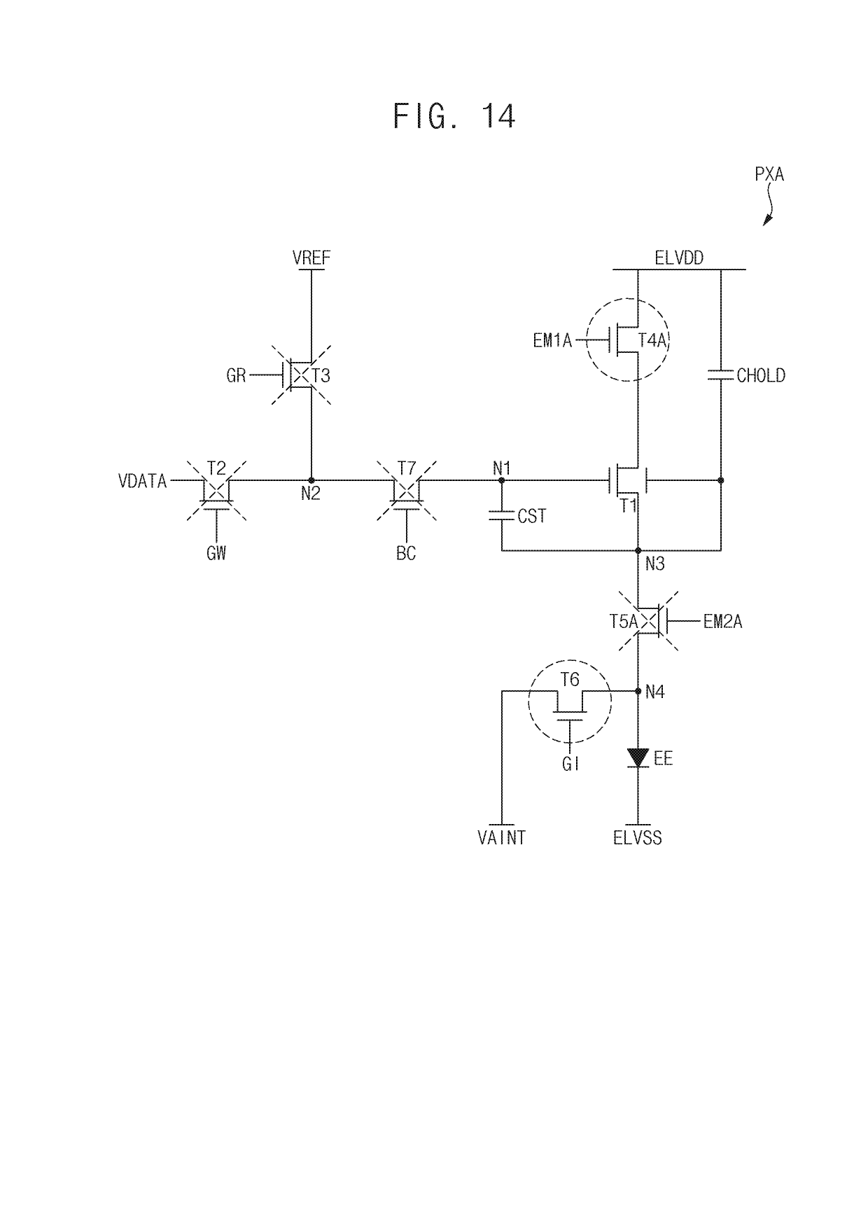

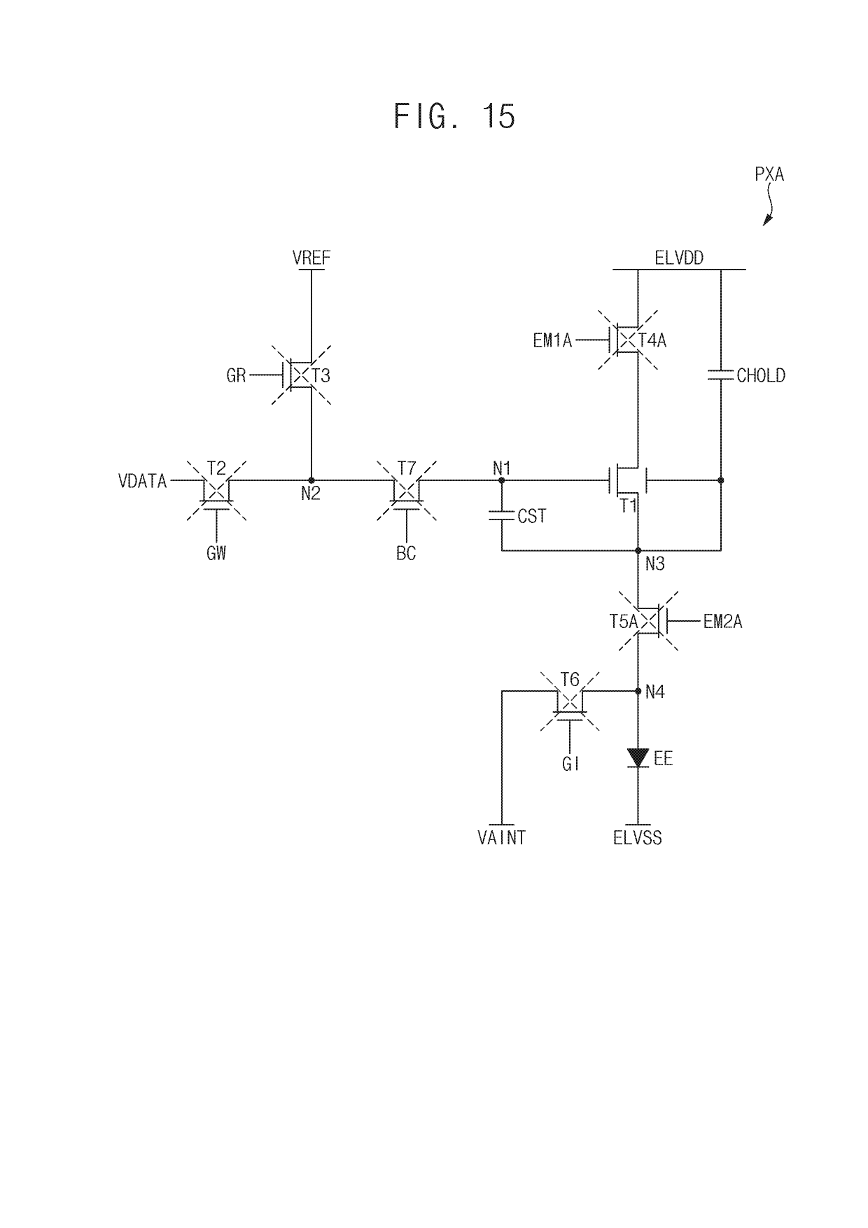

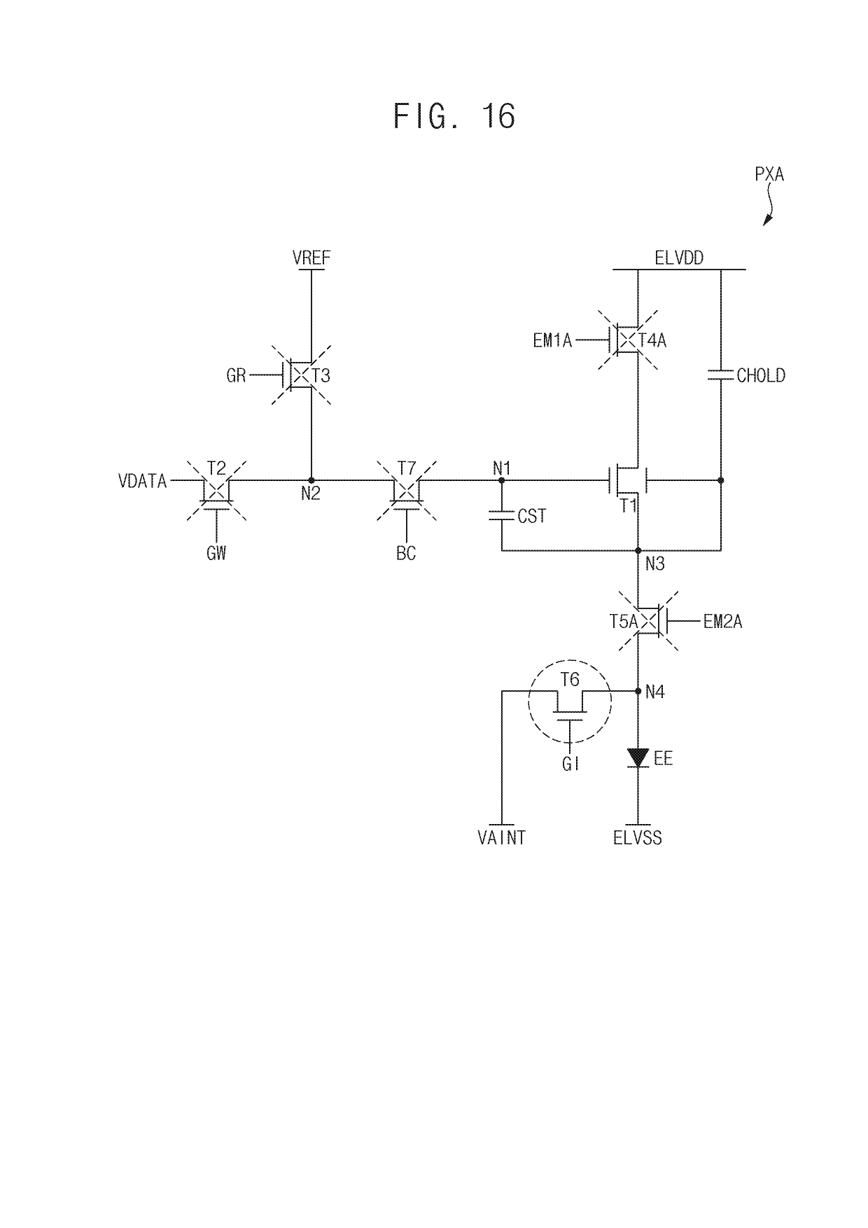

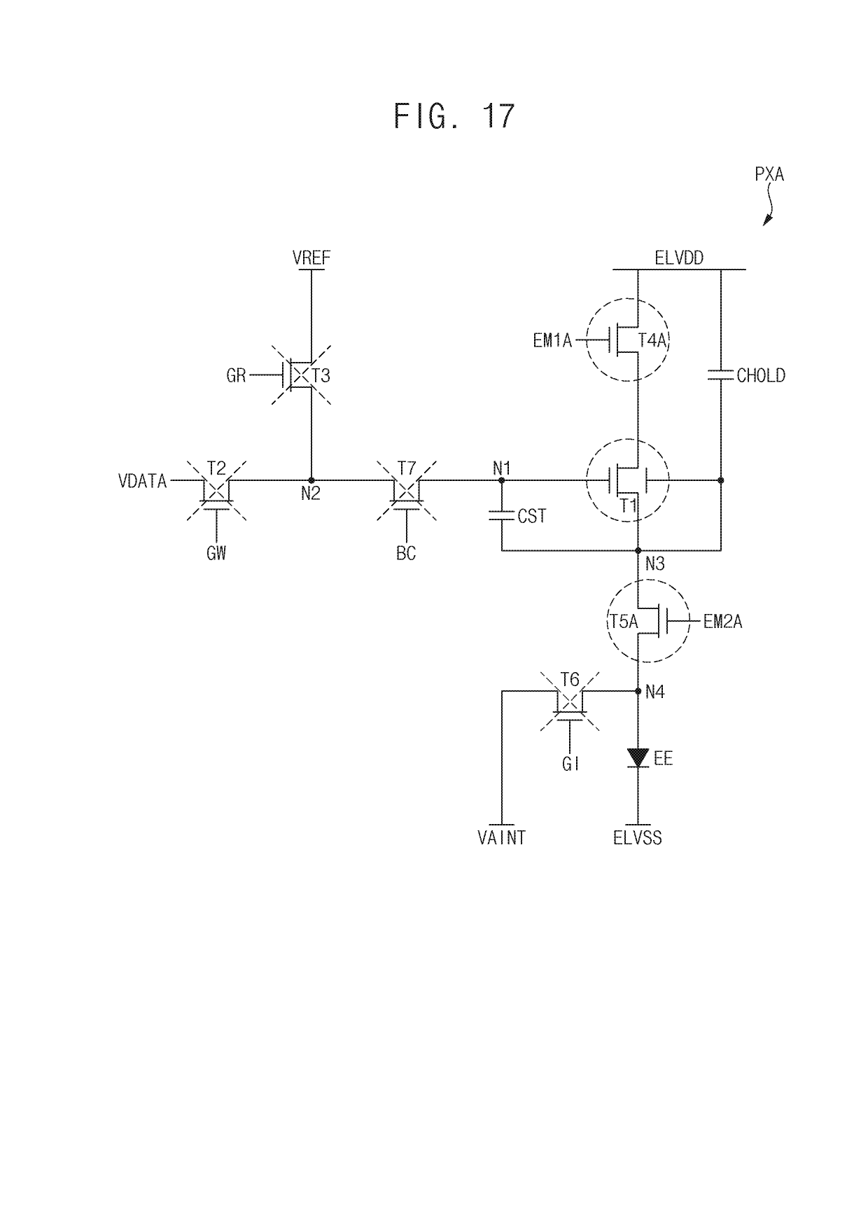

FIG. 12 is a timing diagram illustrating signals applied to a pixel circuit PXA in a self-scan period SS of FIG. 5. FIG. 13 is a circuit diagram illustrating an operation of a pixel circuit PXA in a first period TP1B of FIG. 12. FIG. 14 is a circuit diagram illustrating an operation of a pixel circuit PXA in a second period TP2B of FIG. 12. FIG. 15 is a circuit diagram illustrating an operation of a pixel circuit PXA in a third period TP3B of FIG. 12. FIG. 16 is a circuit diagram illustrating an operation of a pixel circuit PXA in a fourth period TP4B of FIG. 12. FIG. 17 is a circuit diagram illustrating an operation of a pixel circuit PXA in a fifth period TP5B of FIG. 12.

Referring to FIG. 1 to FIG. 5 and FIG. 12 to FIG. 17, the self-scan period SS may include a first period TP1B, a second period TP2B, a third period TP3B, a fourth period TP4B, and a fifth period TP5B.

In the first period TP1B, the first emission signal EM1A may have an inactivation level, the second emission signal EM2A may have an inactivation level, the reset gate signal GR may have an activation level, the initialization gate signal GI may have an activation level, the write gate signal GW may have an inactivation level, and the block control signal BC may have an inactivation level.

In the first period TP1B, the seventh transistor T7 may be turned off in response to the block control signal BC. The seventh transistor T7 may be turned off in response to the block control signal BC, so that the reference voltage VREF may not be applied to the first node N1. Accordingly, the first node N1 may not be initialized as the reference voltage VREF. In the first period TP1B, the fourth transistor T4A may be turned off in response to the first emission signal EM1A. In the first period TP1B, the fifth transistor T5A may be turned off in response to the second emission signal EM2A. In the first period TP1B, the sixth transistor T6 may be turned on in response to the initialization gate signal GI. The sixth transistor T6 may be turned on, so that the initialization voltage VAINT may be applied to the fourth node N4. In the first period TP1B, the light-emitting element EE may stop emitting. For example, the first period TP1B may be called as a second initialization period.

In the second period TP2B, the first emission signal EM1A may have an activation level, the second emission signal EM2A may have an inactivation level, the reset gate signal GR may have an inactivation level, the initialization gate signal GI may have an inactivation level, the write gate signal GW may have an inactivation level, and the block control signal BC may have an inactivation level.

In the second period TP2B, the fourth transistor T4A may be turned on in response to the first emission signal EM1A. The fourth transistor T4A may be turned on, so that the first power voltage ELVDD may be applied to the first transistor T1 (e.g., the first electrode of the first transistor T1). For example, the second period TP2B may be called as a second compensation period.

In the third period TP3B, the first emission signal EM1A may have an inactivation level, the second emission signal EM2A may have an inactivation level, the reset gate signal GR may have an inactivation level, the initialization gate signal GI may have an inactivation level, the write gate signal GW may have an inactivation level, and the block control signal BC may have an inactivation level.

In the third period TP3B, the seventh transistor T7 may be turned off in response to the block control signal BC. The seventh transistor T7 may be turned off, so that the data voltage VDATA may not be applied to the first mode N1. Accordingly, a voltage of the first node N1 may be maintained as a previous data voltage. For example, the previous data voltage may be a data voltage of a previous frame. For example, the third period TP3B may be called as a second write period.

In the fourth period TP4B, the first emission signal EM1A may have an inactivation level, the second emission signal EM2A may have an inactivation level, the reset gate signal GR may have an inactivation level, the initialization gate signal GI may have an activation level, the write gate signal GW may have an inactivation level, and the block control signal BC may have an inactivation level.

In the fourth period TP4B, the sixth transistor T6 may be turned on in response to the initialization gate signal GI. For example, the fourth period TP4B may be called as a second emission waiting period.

In the fifth period TP5B, the first emission signal EM1A may have an activation level, the second emission signal EM2A may have an activation level, the reset gate signal GR may have an inactivation level, the initialization gate signal GI may have an inactivation level, the write gate signal GW may have an inactivation level, and the block control signal BC may have an inactivation level.

In the fifth period TP5B, the fourth transistor T4A may be turned on in response to the first emission signal EM1A. In the fifth period TP5B, the fifth transistor T5A may be turned on in response to the second emission signal EM2A. In the fifth period TP5B, the sixth transistor T6 may be turned off in response to the initialization gate signal GI. In the first period TP1B to the fifth period TP5B, the turned off state of the third transistor T3 may be maintained in response to the reset gate signal GR. In the first period TP1B to the fifth period TP5B, the turned off state of the second transistor T2 may be maintained in response to the write gate signal GW. In the fifth period TP5B, the first transistor T1 may output a previous frame driving current based on the previous data voltage. The first transistor T1, the fourth transistor T4A and the fifth transistor T5A may be turned on, so that the previous frame driving current may be applied to the light-emitting element EE. Accordingly, the light-emitting element EE may emit light based on the previous frame driving current. For example, the fifth period TP5B may be called as a second emission period.

In the self-scan period SS, the block control signal BC may have an inactivation level. In the self-scan period SS, the seventh transistor T7 may be turned off in response to the block control signal BC. In the self-scan period SS, the seventh transistor T7 may be turned off, so that the voltage of the first node N1 may be maintained.

In the self-scan period SS, the pixel circuit PXA may emit light based on the previous data voltage. Accordingly, the display panel 100 may be driven as the multiple division of a driving frequency. Additionally, a power consumption of the display device 1 may be reduced.

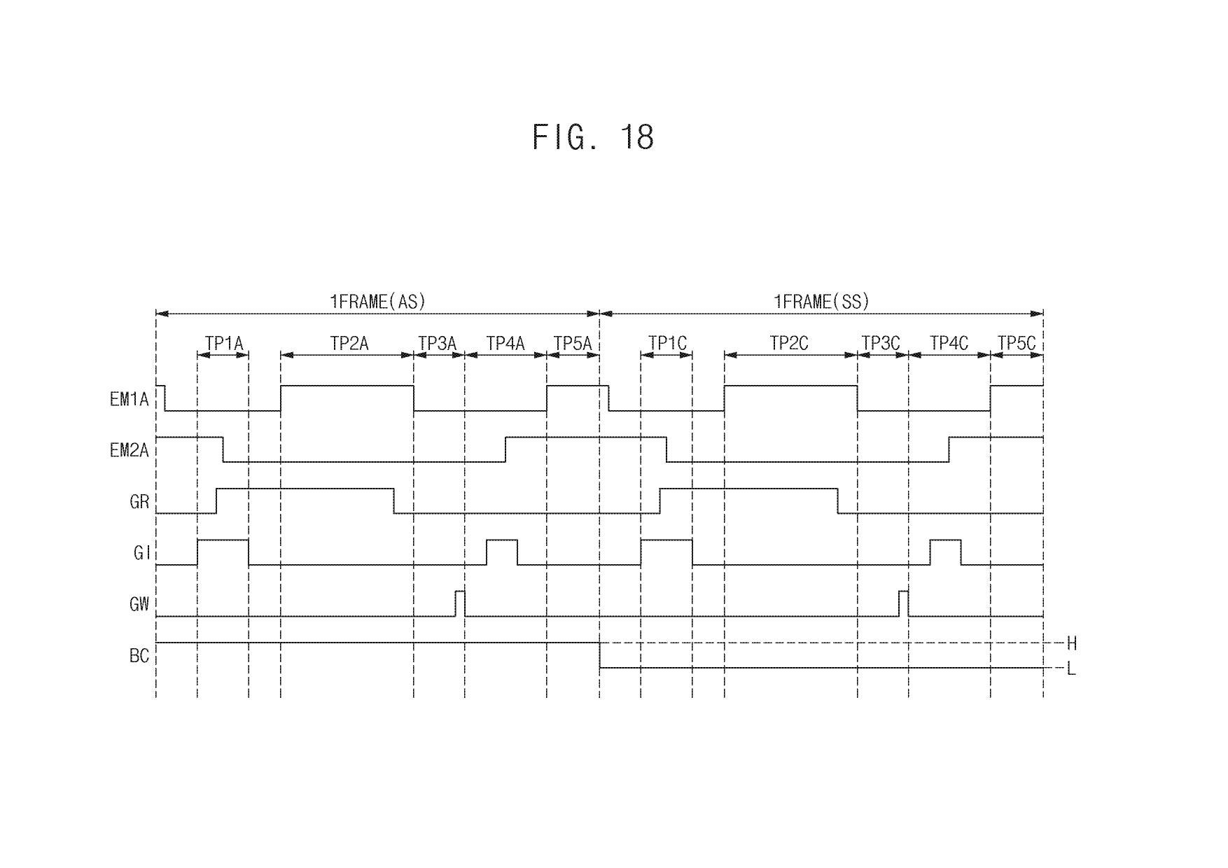

FIG. 18 is a timing diagram illustrating signals applied to a pixel circuit PXA of FIG. 4.

Referring to FIG. 1 to FIG. 4 and FIG. 18, a period in which the pixel circuit PXA is driven may include an address period AS and a self-scan period SS.

In the address period AS, the reset operation and a writing operation may be performed. In the address period AS, the pixel circuit PXA may emit based on a data voltage of the present frame. In the self-scan period SS, the reset operation and the writing operation may not be performed. In the self-scan period SS, the pixel circuit PXA may emit based on a data voltage of the previous frame.

The address period AS may include the first period TP1A, the second period TP2A, the third period TP3A, the fourth period TP4A, and the fifth period TP5A. The self-scan period SS may include a first period TP1C, a second period TP2C, a third period TP3C, a fourth period TP4C, and a fifth period TP5C.

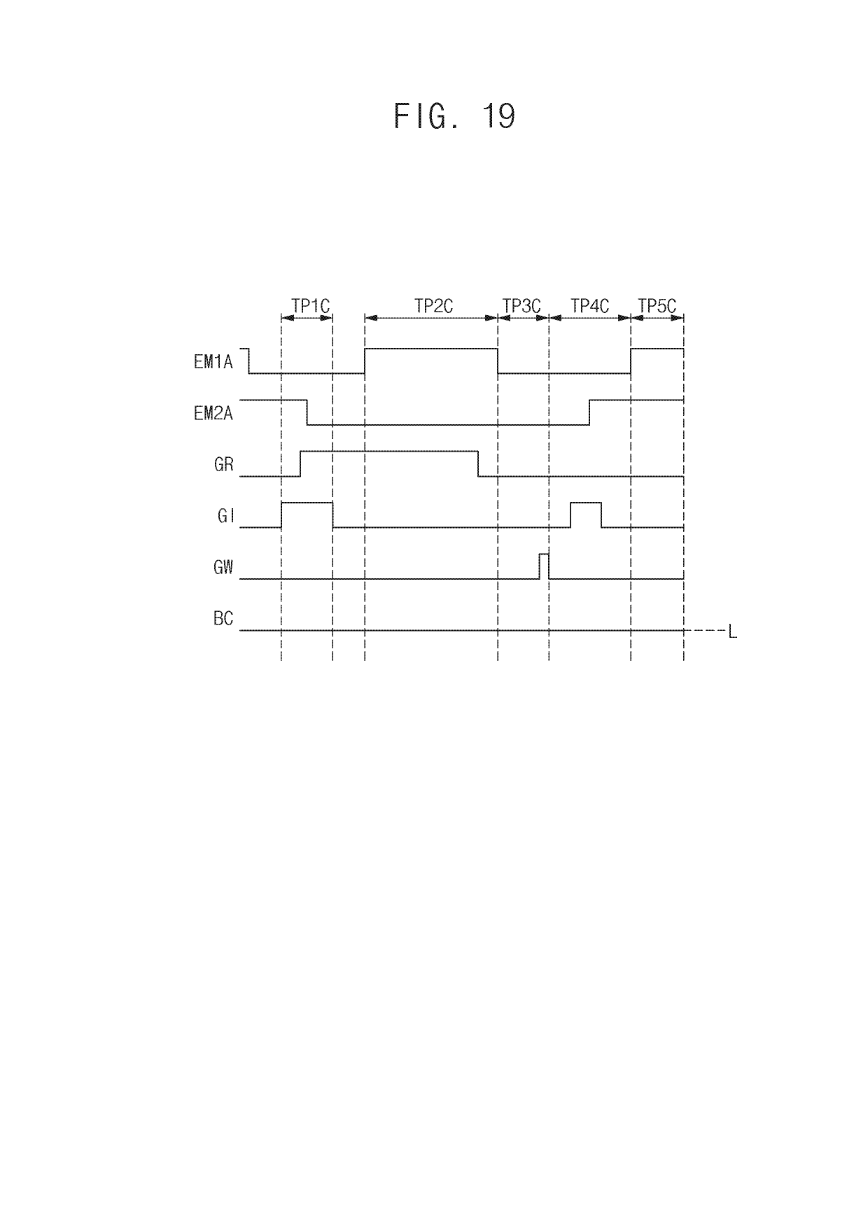

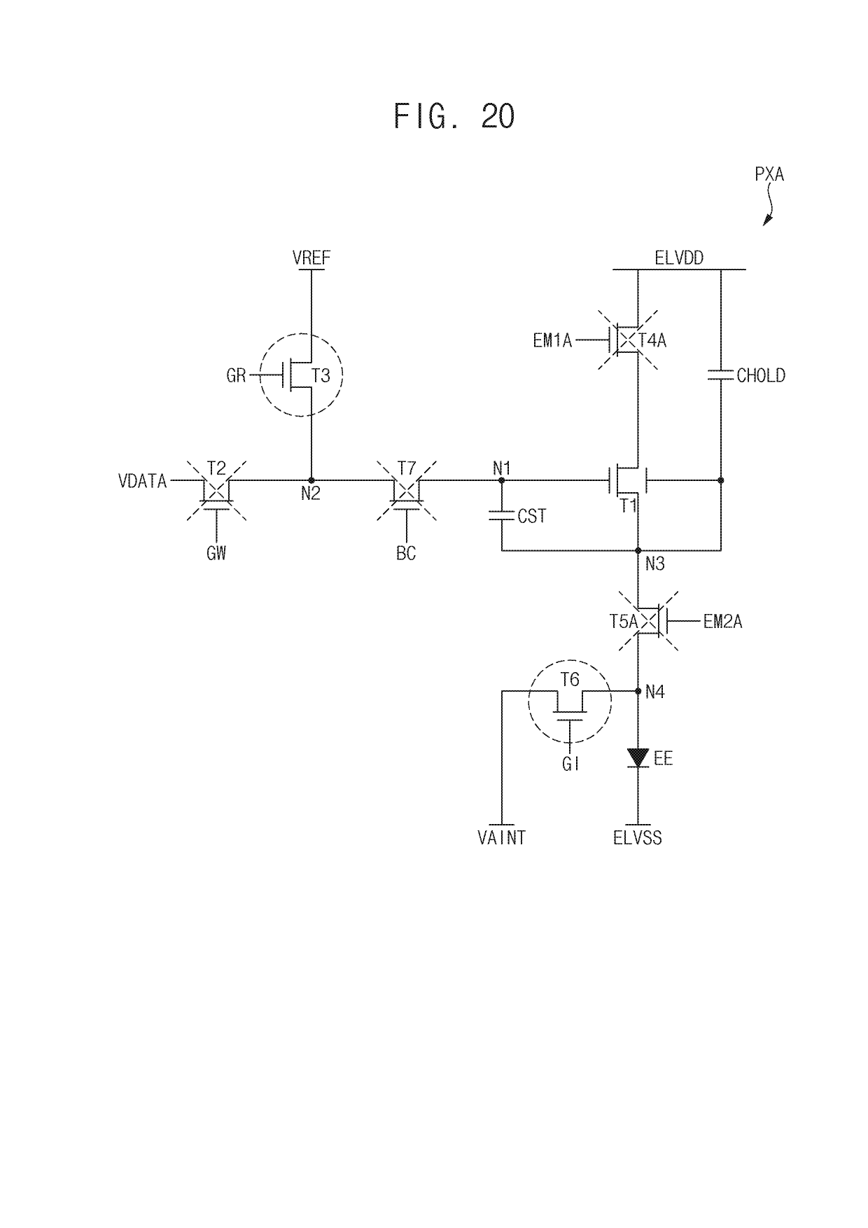

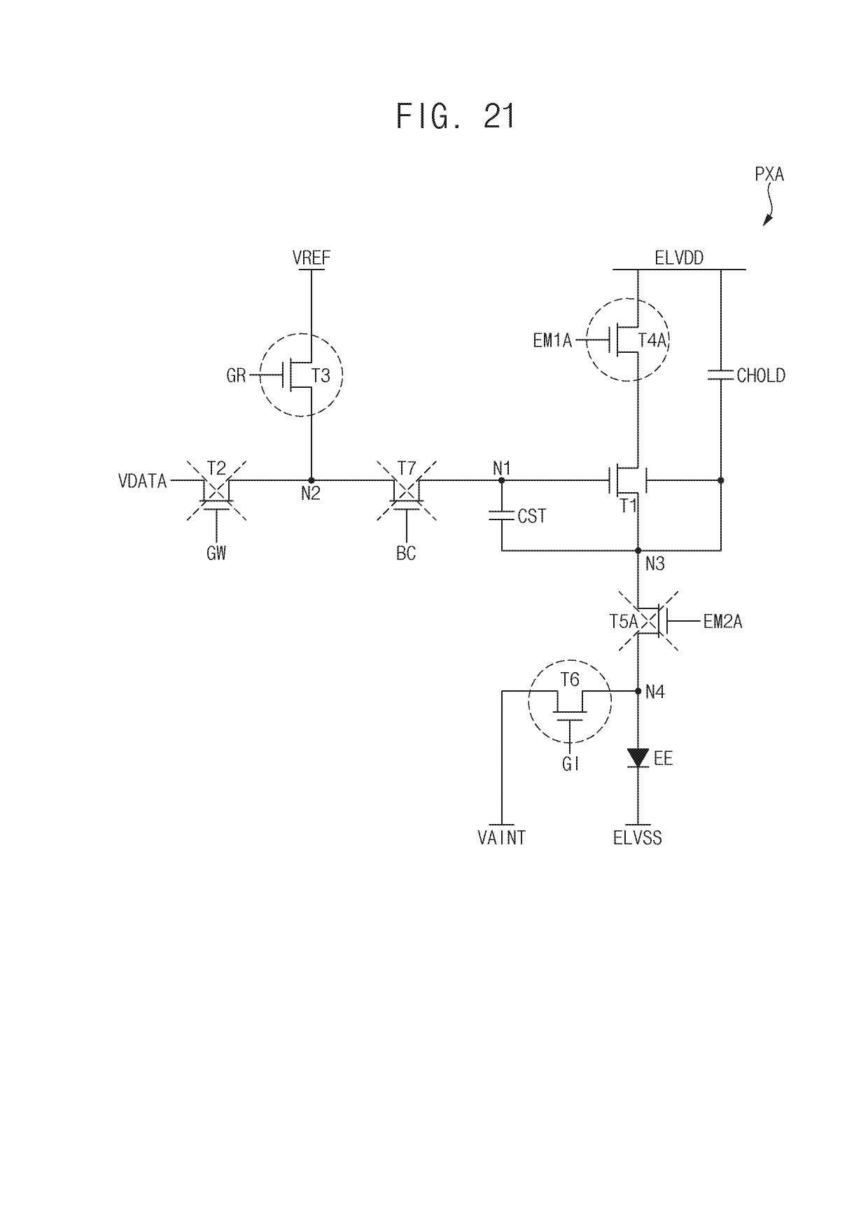

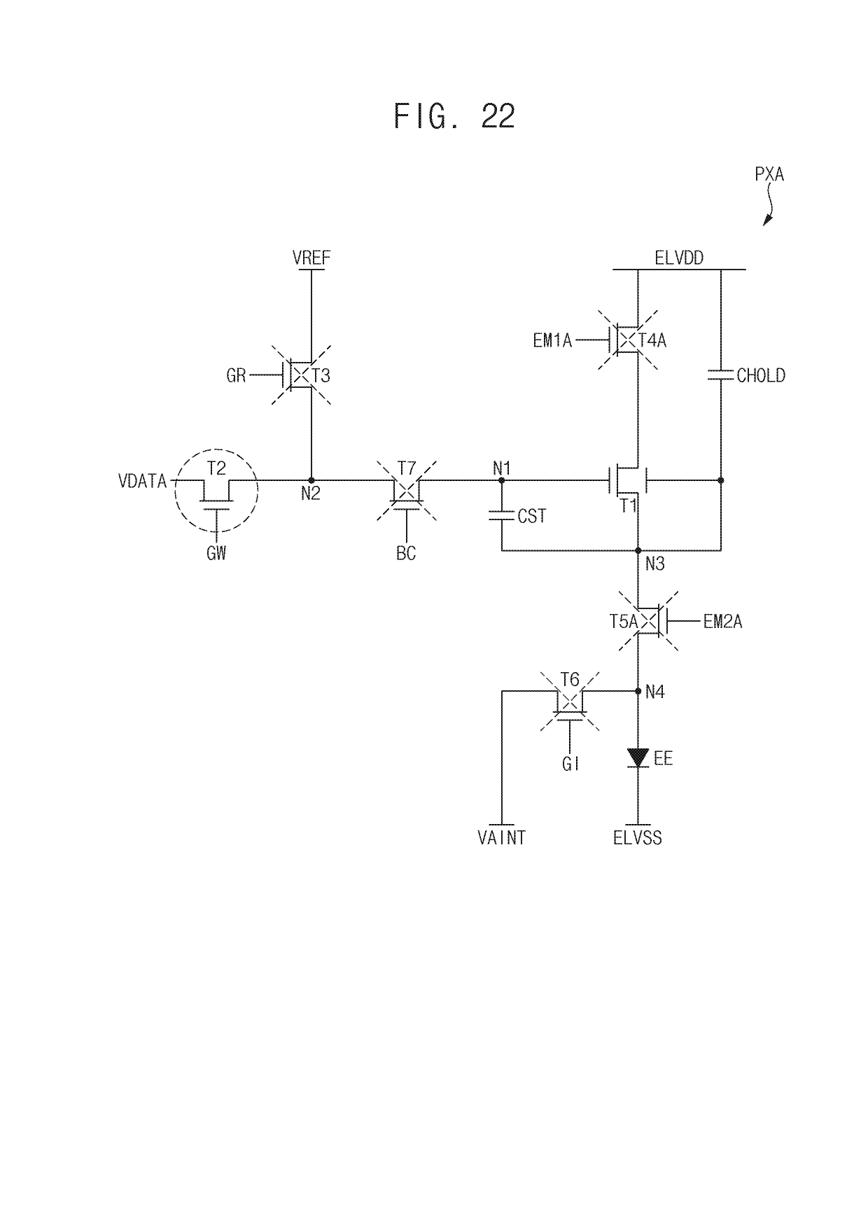

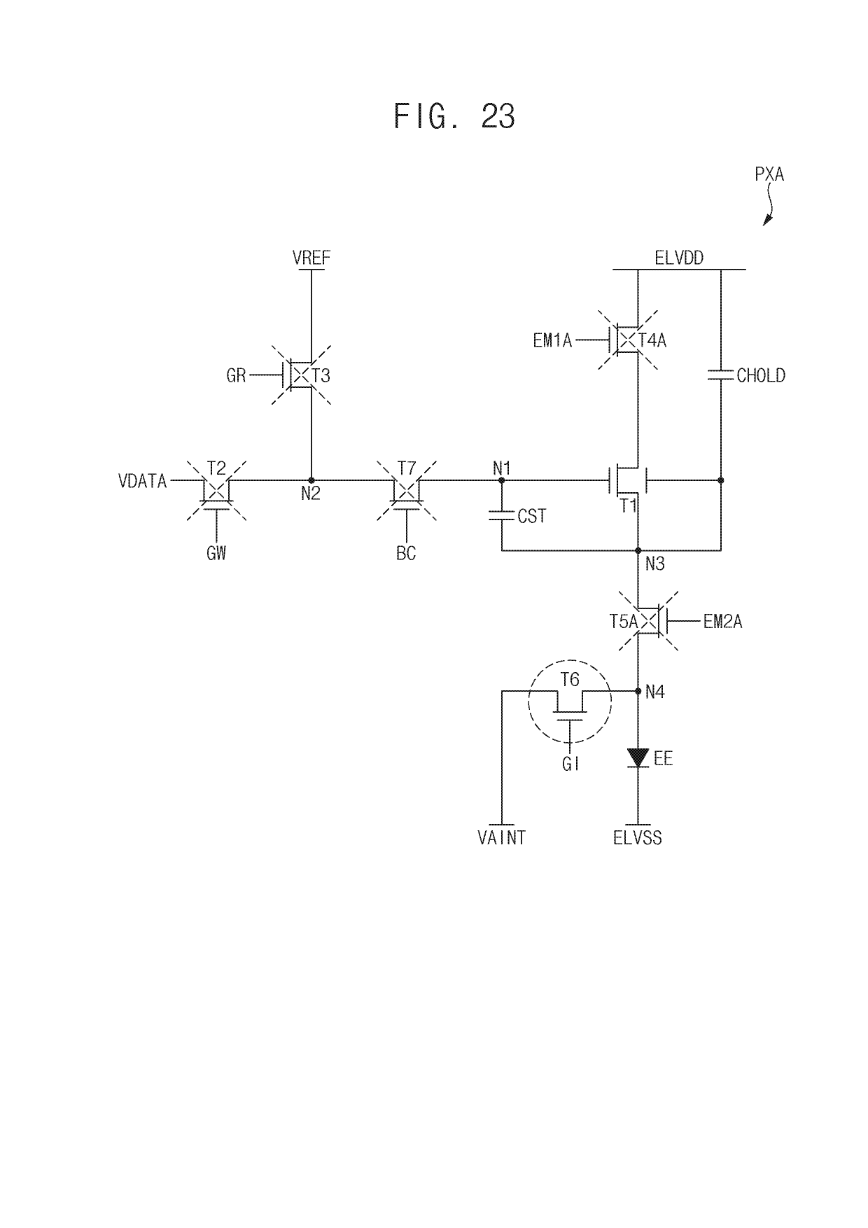

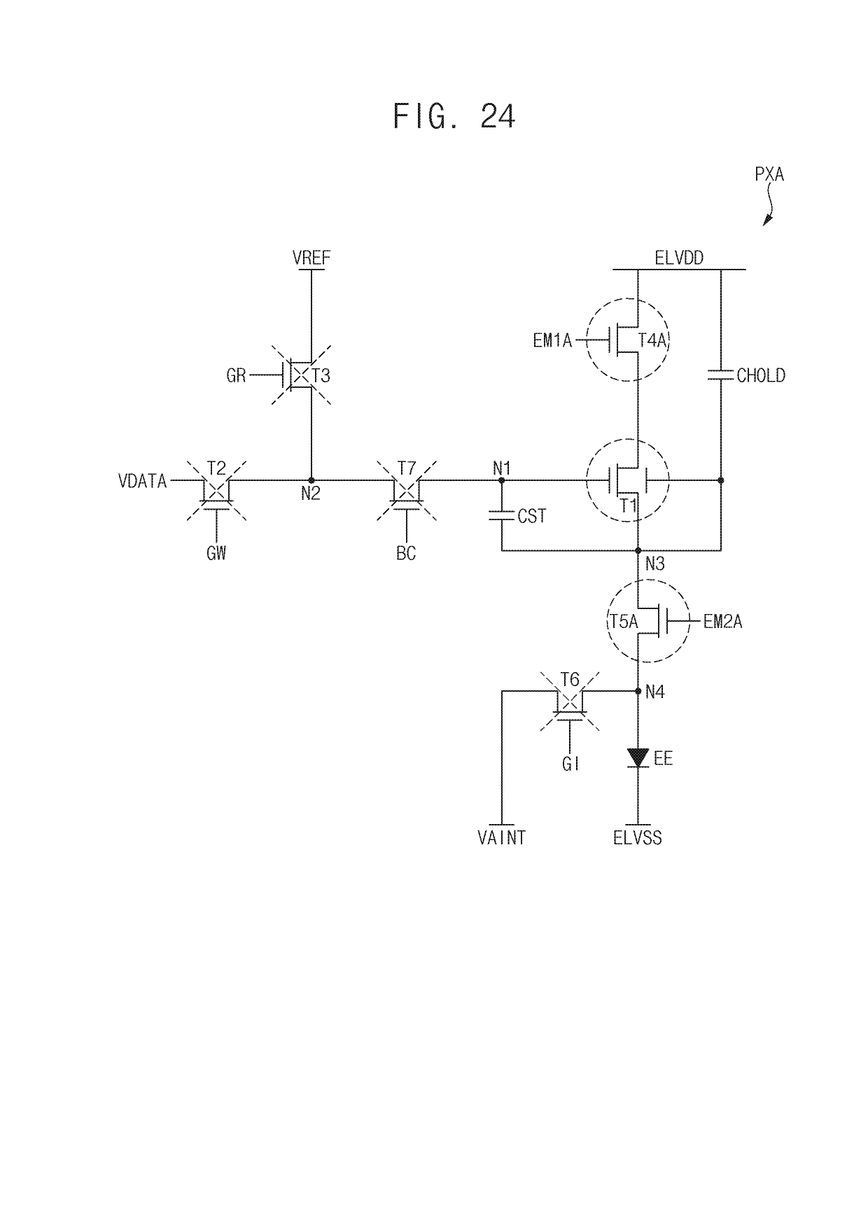

FIG. 19 is a timing diagram illustrating signals applied to a pixel circuit PXA in a self-scan period SS of FIG. 18. FIG. 20 is a circuit diagram illustrating an operation of a pixel circuit PXA in a first period TP1C of FIG. 19. FIG. 21 is a circuit diagram illustrating an operation of a pixel circuit PXA in a second period TP2C of FIG. 19. FIG. 22 is a circuit diagram illustrating an operation of a pixel circuit PXA in a third period TP3C of FIG. 19. FIG. 23 is a circuit diagram illustrating an operation of a pixel circuit PXA in a fourth period TP4C of FIG. 19. FIG. 24 is a circuit diagram illustrating an operation of a pixel circuit PXA in a fifth period TP5C of FIG. 19.

Referring to FIG. 1 to FIG. 4 and FIG. 18 to FIG. 24, the self-scan period SS may include a first period TP1C, a second period TP2C, a third period TP3C, a fourth period TP4C, and a fifth period TP5C.

In the first period TP1C, the first emission signal EM1A may have an inactivation level, the second emission signal EM2A may have an inactivation level, the reset gate signal GR may have an activation level, the initialization gate signal GI may have an activation level, the write gate signal GW may have an inactivation level, and the block control signal BC may have an inactivation level.

In the first period TP1C, the third transistor T3 may be turned on in response to the reset gate signal GR. In the first period TP1C, the seventh transistor T7 may be turned off in response to the block control signal BC. The seventh transistor T7 may be turned off in response to the block control signal BC, so that the reference voltage VREF may not be applied to the first node N1. Accordingly, the first node N1 may not be initialized as the reference voltage VREF. In the first period TP1C, the fourth transistor T4A may be turned off in response to the first emission signal EM1A. In the first period TP1C, the fifth transistor T5A may be turned off in response to the second emission signal EM2A. In the first period TP1C, the sixth transistor T6 may be turned on in response to the initialization gate signal GI. The sixth transistor T6 may be turned on, so that the initialization voltage VAINT may be applied to the fourth node N4. In the first period TP1C, the light-emitting element EE may stop emitting. For example, the first period TP1C may be called as a second initialization period.

In the second period TP2C, the first emission signal EM1A may have an activation level, the second emission signal EM2A may have an inactivation level, the reset gate signal GR may have an activation level, the initialization gate signal GI may have an inactivation level, the write gate signal GW may have an inactivation level, and the block control signal BC may have an inactivation level.

In the second period TP2C, the fourth transistor T4A may be turned on in response to the first emission signal EM1A. The fourth transistor T4A may be turned on, so that the first power voltage ELVDD may be applied to the first transistor T1. For example, the second period TP2C may be called as a second compensation period.

In the third period TP3C, the first emission signal EM1A may have an inactivation level, the second emission signal EM2A may have an inactivation level, the reset gate signal GR may have an inactivation level, the initialization gate signal GI may have an inactivation level, the write gate signal GW may have an activation level, and the block control signal BC may have an inactivation level.

In the third period TP3C, the third transistor T3 may be turned off in response to the reset gate signal GR. In the third period TP3C, the second transistor T2 may be turned on in response to the write gate signal GW. In the third period TP3C, the seventh transistor T7 may be turned off in response to the block control signal BC. The seventh transistor T7 may be turned off, so that the data voltage VDATA may not be applied to the first mode N1. Accordingly, a voltage of the first node N1 may be maintained as a previous data voltage. For example, the previous data voltage may be a data voltage of a previous frame. For example, the third period TP3C may be called as a second write period.

In the fourth period TP4C, the first emission signal EM1A may have an inactivation level, the second emission signal EM2A may have an inactivation level, the reset gate signal GR may have an inactivation level, the initialization gate signal GI may have an activation level, the write gate signal GW may have an inactivation level, and the block control signal BC may have an inactivation level.

In the fourth period TP4C, the second transistor T2 may be turned off in response to the write gate signal GW. In the fourth period TP4C, the sixth transistor T6 may be turned on in response to the initialization gate signal GI. For example, the fourth period TP4C may be called as a second emission waiting period.

In the fifth period TP5C, the first emission signal EM1A may have an activation level, the second emission signal EM2A may have an activation level, the reset gate signal GR may have an inactivation level, the initialization gate signal GI may have an inactivation level, the write gate signal GW may have an inactivation level, and the block control signal BC may have an inactivation level.

In the fifth period TP5C, the fourth transistor T4A may be turned on in response to the first emission signal EM1A. In the fifth period TP5C, the fifth transistor T5A may be turned on in response to the second emission signal EM2A. In the fifth period TP5C, the sixth transistor T6 may be turned off in response to the initialization gate signal GI. In the fifth period TP5C, the first transistor T1 may output a previous frame driving current based on the previous data voltage. The first transistor T1, the fourth transistor T4A and the fifth transistor T5A may be turned on, so that the previous frame driving current may be applied to the light-emitting element EE. Accordingly, the light-emitting element EE may emit light based on the previous frame driving current. For example, the fifth period TP5C may be called as a second emission period.

In the self-scan period SS, the block control signal BC may have an inactivation level. In the self-scan period SS, the seventh transistor T7 may be turned off in response to the block control signal BC. In the self-scan period SS, the seventh transistor T7 may be turned off, so that the voltage of the first node N1 may be maintained.

In the self-scan period SS, the pixel circuit PXA may emit light based on the previous data voltage. Accordingly, the display panel 100 may be driven as the multiple division of a driving frequency. Additionally, a power consumption of the display device 1 may be reduced.

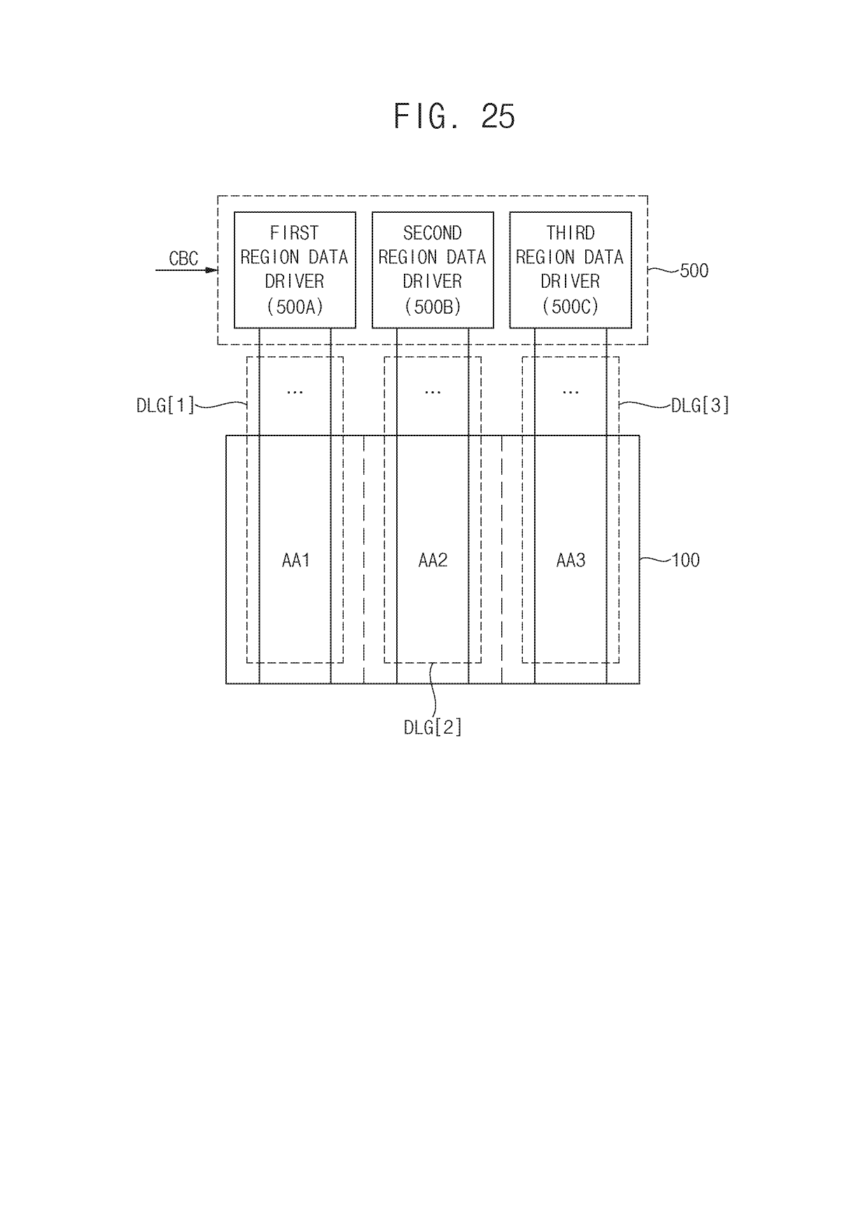

FIG. 25 is a block diagram illustrating an example of a data driver 500 of FIG. 1 and a display panel 100 of FIG. 1.

Referring to FIG. 1 to FIG. 5 and FIG. 25, the data driver 500 may include a first region data driver 500A, a second region data driver 500B, and a third region data driver 500C. The first region data driver 500A may output the data voltage VDATA to a first display region AA1. The second region data driver 500B may output the data voltage VDATA to a second display region AA2. The third region data driver 500C may output the data voltage VDATA to a third display region AA3.

The first region data driver 500A may be connected to the pixel circuits PX included in the first display region AA1 through a first region data line group DLG[1]. The second region data driver 500B may be connected to the pixel circuits PX included in the second display region AA2 through a second region data line group DLG[2]. The third region data driver 500C may be connected to the pixel circuits PX included in the third display region AA3 through a third region data line group DLG[3].

For example, when the block control signal BC having an inactivation level is applied to the pixel circuit PX included in the first display region AA1, the first region data driver 500A may be turned off. For example, when the block control signal BC having an inactivation level is applied to the pixel circuit PX included in the second display region AA2, the second region data driver 500B may be turned off. For example, when the block control signal BC having an inactivation level is applied to the pixel circuit PX included in the third display region AA3, the third region data driver 500C may be turned off.

The first region data driver 500A, the second region data driver 500B, and/or the third region data driver 500C may be turned off based on the block control signal BC. The first region data driver 500A, the second region data driver 500B, and/or the third region data driver 500C may be turned off based on the block control signal BC, so that a power consumption of the display device 1 may be further reduced.

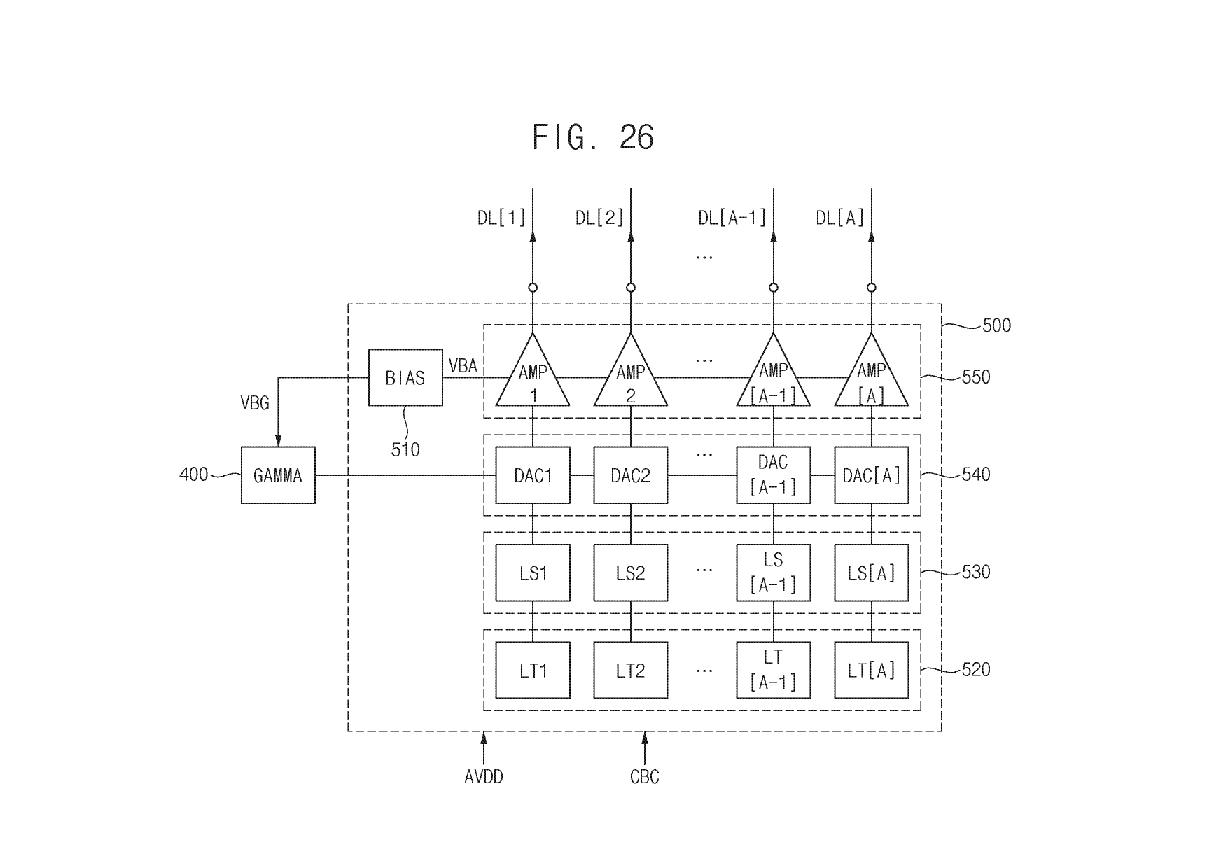

FIG. 26 is a block diagram illustrating an example of the first region data driver 500A, the second region data driver 500B, and/or the third region data driver 500C of FIG. 25.

Referring to FIG. 1 to FIG. 5 and FIG. 25 to FIG. 26, the first region data driver 500A, the second region data driver 500B, and/or the third region data driver 500C may include a bias-voltage-applying block 510, a latch block 520, a level-shifting block 530, a digital-to-analog converting block 540 and an amplifying block 550.

The latch block 520 may include a plurality of latches LT1 to LT[A] corresponding to each of data lines. The level-shifting block 530 may include a plurality of level shifters LS[1] to LS[A] corresponding to each of data lines. The digital-to-analog converting block 540 may include a plurality of digital-to-analog convertors DAC1 to DAC[A] corresponding to each of data lines. The amplifying block 550 may include a plurality of amplifiers AMP1 to AMP[A] corresponding to each of data lines.

The latch block 520 may store the data signal DATA by receiving the data signal DATA from the driving controller 200.

The level-shifting block 530 may convert a low level of the data signal DATA to a high level of the data signal DATA.

The digital-to-analog converting block 540 may convert the high level of the data signal DATA the data voltage VDATA having an analog type based on the gamma reference voltage VGREF.

The bias-voltage-applying block 510 may output a first bias voltage VBG to the gamma reference voltage generator 400. The bias-voltage-applying block 510 may output a second bias voltage VBA to the amplifying block 550.

The amplifying block 550 may operate based on the second bias voltage VBA. For example, when the second bias voltage VBA is applied, the amplifying block 550 may output the data voltage VDATA to the data lines DL[1], DL[2],… DL[A-1], and DL[A]. For example, when the second bias voltage VBA is not applied, the data voltage VDATA may not be outputted to the data lines DL[1], DL[2],… DL[A-1], and DL[A].

The data driver 500 may generate the data voltage VDATA based on a high data power voltage AVDD. In one or more embodiments, the display device 1 may further include a voltage generator. For example, the high data power voltage AVDD may be applied from the voltage generator.

The data driver 500 may receive the block-driving control signal CBC. The data driver 500 may be turned off in response to the block-driving control signal CBC.

For example, when the first region data driver 500A is turned off in response to the block-driving control signal CBC, the bias-voltage-applying block 510 included in the first region data driver 500A may not apply the second bias voltage VBA. The second bias voltage VBA may not be applied to the amplifying block 550 included in the first region data driver 500A, so that the amplifying block 550 included in the first region data driver 500A may be turned off. The amplifying block 550 included in the first region data driver 500A may be turned off, so that a power consumption of the display device 1 may be further reduced.

Additionally, for example, when the first region data driver 500A is turned off in response to the block-driving control signal CBC, the high data power voltage AVDD may not be applied to the first region data driver 500A. The high data power voltage AVDD may not be applied to the first region data driver 500A, so that a power consumption of the display device 1 may be further reduced.

For example, when the second region data driver 500B is turned off in response to the block-driving control signal CBC, the bias-voltage-applying block 510 included in the second region data driver 500B may not apply the second bias voltage VBA. The second bias voltage VBA may not be applied to the amplifying block 550 included in the second region data driver 500B, so that the amplifying block 550 included in the second region data driver 500B may be turned off. The amplifying block 550 included in the second region data driver 500B may be turned off, so that a power consumption of the display device 1 may be further reduced.

Additionally, for example, when the second region data driver 500B is turned off in response to the block-driving control signal CBC, the high data power voltage AVDD may not be applied to the second region data driver 500B. The high data power voltage AVDD need not be applied to the second region data driver 500B, so that a power consumption of the display device 1 may be further reduced.

For example, when the third region data driver 500C is turned off in response to the block-driving control signal CBC, the bias-voltage-applying block 510 included in the third region data driver 500C need not apply the second bias voltage VBA. The second bias voltage VBA need not be applied to the amplifying block 550 included in the third region data driver 500C, so that the amplifying block 550 included in the third region data driver 500C may be turned off. The amplifying block 550 included in the third region data driver 500C may be turned off, so that a power consumption of the display device 1 may be further reduced.

Additionally, for example, when the third region data driver 500C is turned off in response to the block-driving control signal CBC, the high data power voltage AVDD need not be applied to the third region data driver 500C. The high data power voltage AVDD need not be applied to the third region data driver 500C, so that a power consumption of the display device 1 may be further reduced.

The display panel 100 may be driven as multiple division of the driving frequency. The display panel 100 may be driven as multiple division of the driving frequency, so that a power consumption of the display device may be reduced. For example, the display panel 100 may be driven as a horizontal multiple division of the driving frequency.

Additionally, when the display panel 100 may be driven as a horizontal multiple division of the driving frequency, the first region data driver 500A, the second region data driver 500B, and/or the third region data driver 500C may be turned off in response to the block-driving control signal CBC, so that a power consumption of the display device 1 may be further reduced.

Additionally, when the display panel 100 may be driven as a horizontal multiple division of the driving frequency, the amplifying block 550 included in the first region data driver 500A, the second region data driver 500B, and/or the third region data driver 500C may be turned off. Accordingly, a power consumption of the display device 1 may be further reduced.

Additionally, when the display panel 100 may be driven as a horizontal multiple division of the driving frequency, the high data power voltage AVDD may not be applied to the first region data driver 500A, the second region data driver 500B, and/or the third region data driver 500C. Accordingly, a power consumption of the display device 1 may be further reduced.

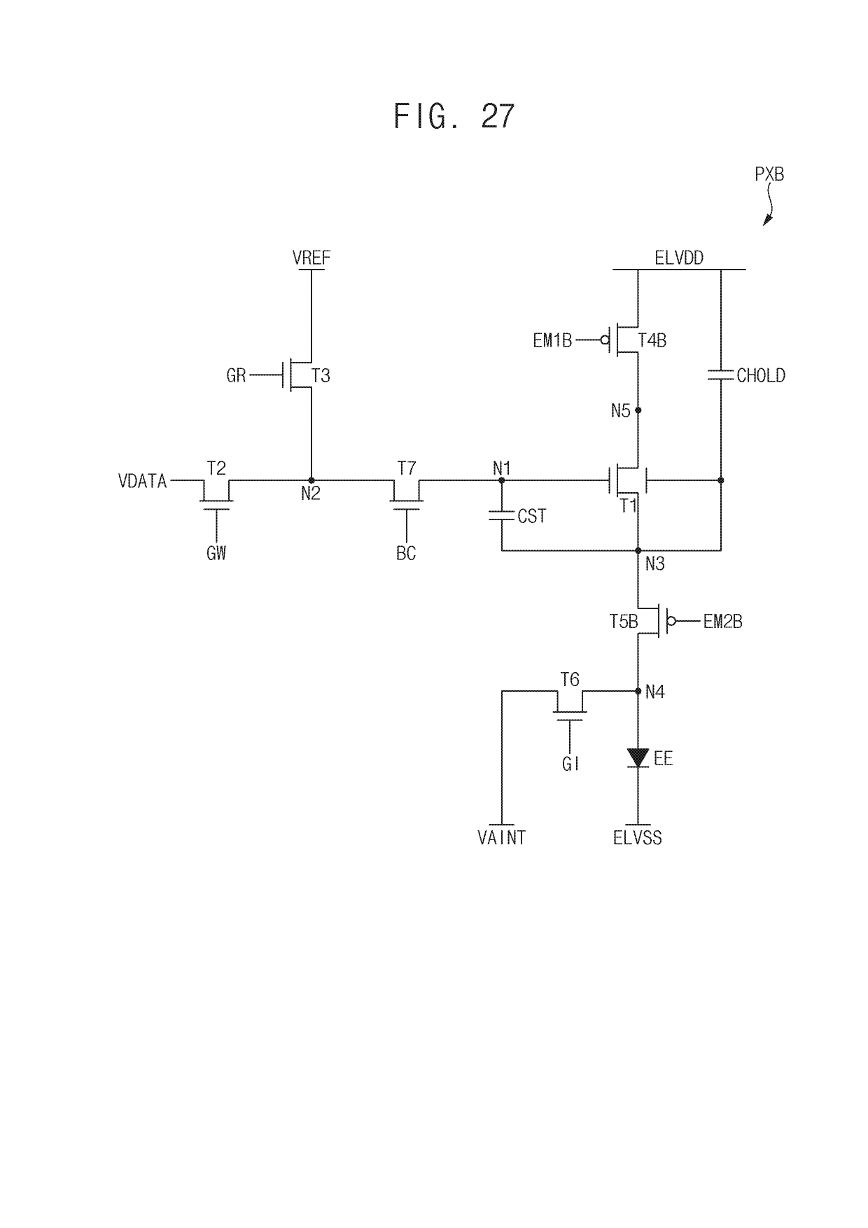

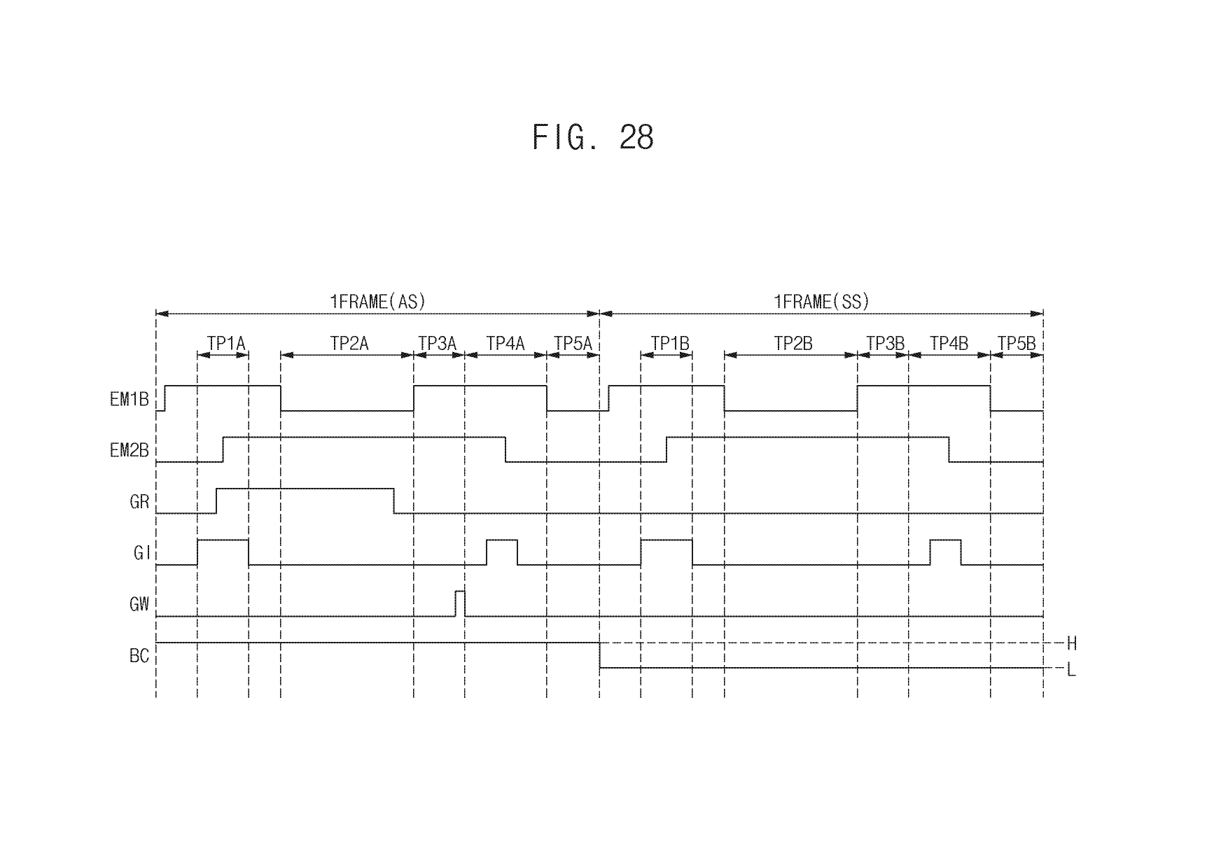

FIG. 27 is a circuit diagram illustrating an example of a pixel circuit PX of FIG. 1. FIG. 28 is a timing diagram illustrating signals applied to a pixel circuit PXB of FIG. 27.

Referring to FIG. 27, the pixel circuit PXB may include first to seventh transistors T1, T2, T3, T4B, T5B, T6, and T7.

The pixel circuit PXB of FIG. 27 is substantially the same as the pixel circuit PXA of FIG. 4, except that the fourth transistor T4B and the fifth transistor T5B are P-type transistors. Accordingly, the same reference numerals will be used to refer to the same, and any repetitive explanation concerning the above elements will be omitted.

Additionally, a timing diagram of FIG. 28 is substantially the same as a timing diagram of FIG. 5, except that an activation level of a first emission signal EM1B and a second emission signal EM2B is a logic low level, and that an inactivation level of a first emission signal EM1B and a second emission signal EM2B is a logic high level. Accordingly, the same reference numerals will be used to refer to the same and any repetitive explanation concerning the above elements will be omitted.

Referring to FIG. 27, the fourth transistor T4B may include a control electrode for receiving the first emission signal EM1B, a first electrode for receiving the first power voltage ELVDD, and a second electrode connected to the fifth node N5. The fifth transistor T5B may include a control electrode for receiving the second emission signal EM2B, a first electrode connected to the third node N3, and a second electrode connected to the fourth transistor N4.

The pixel circuit PXB may include a transistor of a first type and a transistor of a second type different from the first type. For example, the transistor of the first type may be a polysilicon thin film transistor. For example, the transistor of the first type may be a low temperature polysilicon (LTPS) thin film transistor. For example, the transistor of the second type may be an oxide thin film transistor. For example, the transistor of the first type may be a P-type transistor and the transistor of the second type may be an N-type transistor.

Although some of the transistors of the pixel circuit PXB are the oxide thin film transistors and other transistor of the pixel circuit PXB are the polysilicon thin film transistors the present disclosure may not be limited thereto. The present disclosure may be applied to cases of a pixel including only oxide thin film transistors. Although some of the transistors of the pixel are the N-type transistors and other transistors of pixel are the P-type transistors the present disclosure may not be limited thereto. The present disclosure may be applied to cases of a pixel including only the N-type transistors.

The first transistor T1, the second transistor T2, the third transistor T3, the sixth transistor T6, and the seventh transistor T7 may be N-type transistors. The fourth transistor T4B and the fifth transistor T5B may be P-type transistors.

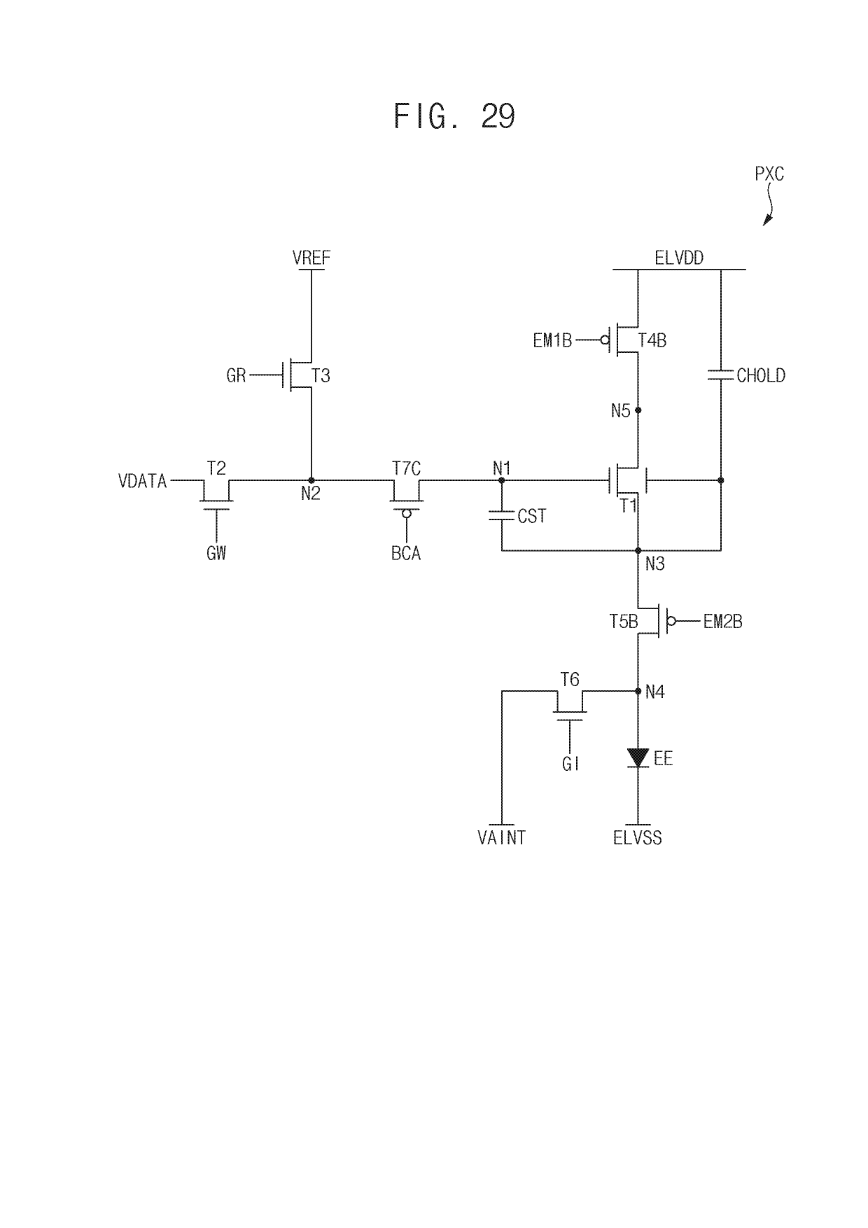

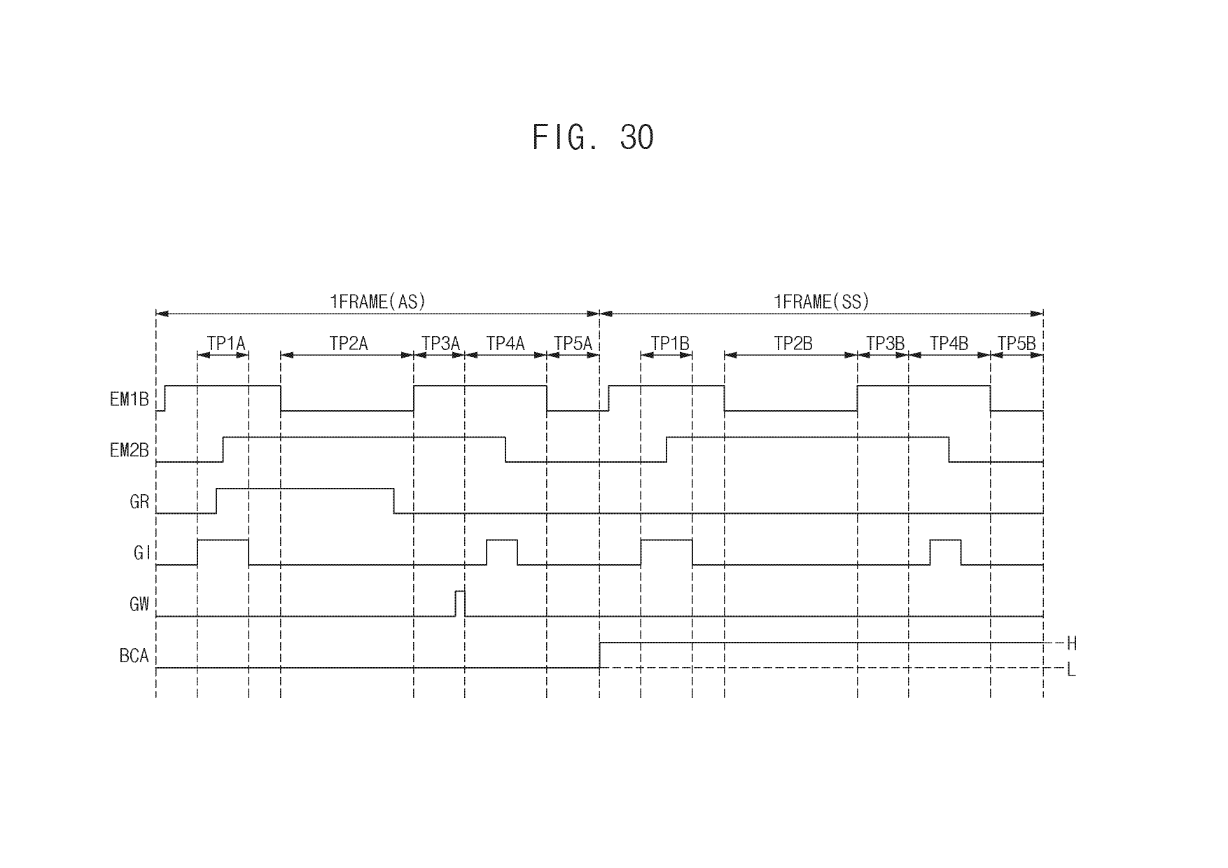

FIG. 29 is a circuit diagram illustrating an example of a pixel circuit PX of FIG. 1. FIG. 30 is a timing diagram illustrating signals applied to a pixel circuit PXC of FIG. 29.

Referring to FIG. 27, the pixel circuit PXB may include first to seventh transistors T1, T2, T3, T4B, T5B, T6, and T7.

The pixel circuit PXB of FIG. 29 is substantially the same as the pixel circuit PXA of FIG. 4 except that the fourth transistor T4B, the fifth transistor T5B, and the seventh transistor T7C are P-type transistors. Accordingly, the same reference numerals will be used to refer to the same and any repetitive explanation concerning the above elements will be omitted.

Additionally, a timing diagram of FIG. 30 is substantially the same as a timing diagram of FIG. 5 except that an activation level of a first emission signal EM1B and a second emission signal EM2B is a logic low level, an inactivation level of a first emission signal EM1B and a second emission signal EM2B is a logic high level, an activation level of a bloc control signal BCA is a logic high level, and an inactivation level of a block control signal BCA is a logic low level. Accordingly, the same reference numerals will be used to refer to the same and any repetitive explanation concerning the above elements will be omitted.

Referring to FIG. 29 and FIG. 30, the fourth transistor T4B may include a control electrode for receiving the first emission signal EM1B, a first electrode for receiving the first power voltage ELVDD, and a second electrode connected to the fifth node N5. The fifth transistor T5B may include a control electrode for receiving the second emission signal EM2B, a first electrode connected to the third node N3, and a second electrode connected to the fourth transistor N4. The seventh transistor T7C may include a control electrode for receiving the block control signal BCA, a first electrode connected to the second node N2, and a second electrode connected to the first node N1.

The pixel circuit PXC may include a transistor of a first type and a transistor of a second type different from the first type. For example, the transistor of the first type may be a polysilicon thin film transistor. For example, the transistor of the first type may be a low temperature polysilicon (LTPS) thin film transistor. For example, the transistor of the second type may be an oxide thin film transistor. For example, the transistor of the first type may be a P-type transistor and the transistor of the second type may be an N-type transistor.

Although some of the transistors of the pixel circuit PXC are the oxide thin film transistors and other transistor of the pixel circuit PXC are the polysilicon thin film transistors the present disclosure may not be limited thereto. The present disclosure may be applied to cases of a pixel including only oxide thin film transistors. Although some of the transistors of the pixel are the N-type transistors and other transistors of pixel are the P-type transistors, the present disclosure is not limited thereto. For example, the present disclosure may be applied to cases of a pixel including only the N-type transistors.

The first transistor T1, the second transistor T2, the third transistor T3, and the sixth transistor T6 may be N-type transistors. The fourth transistor T4B, the fifth transistor T5B, and the seventh transistor T7C may be P-type transistors.

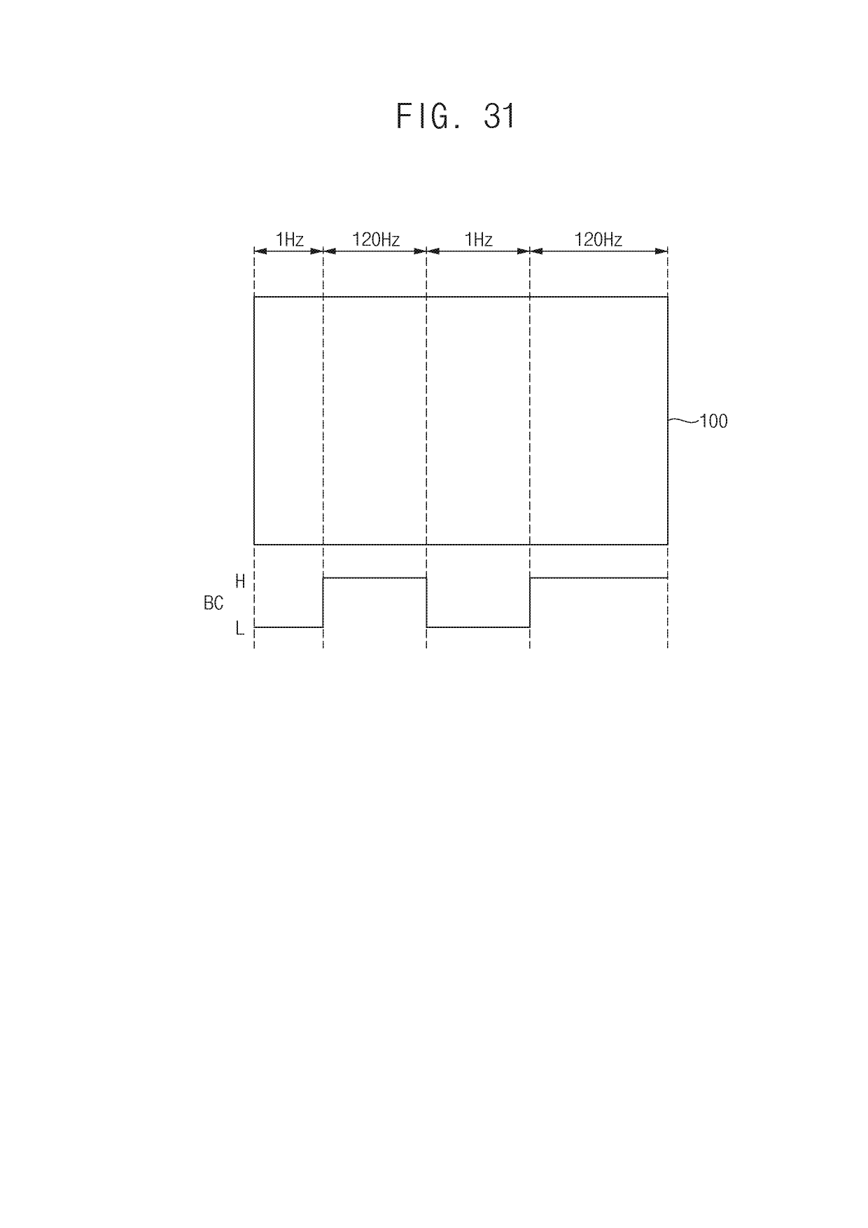

FIG. 31 is a conceptual diagram illustrating a block control signal outputted from a block control driver of FIG. 1 according to driving frequencies of portions of the display panel of FIG. 1.

Referring to FIG. 1 to FIG. 3 and FIG. 31, the display panel 100 may further include a fourth display region. The display panel 100 may emit as a different frequency based on the block control signal BC. However, the present disclosure is not limited to the number of the display region in which the display panel is driven as a horizontal multiple division of a driving frequency.

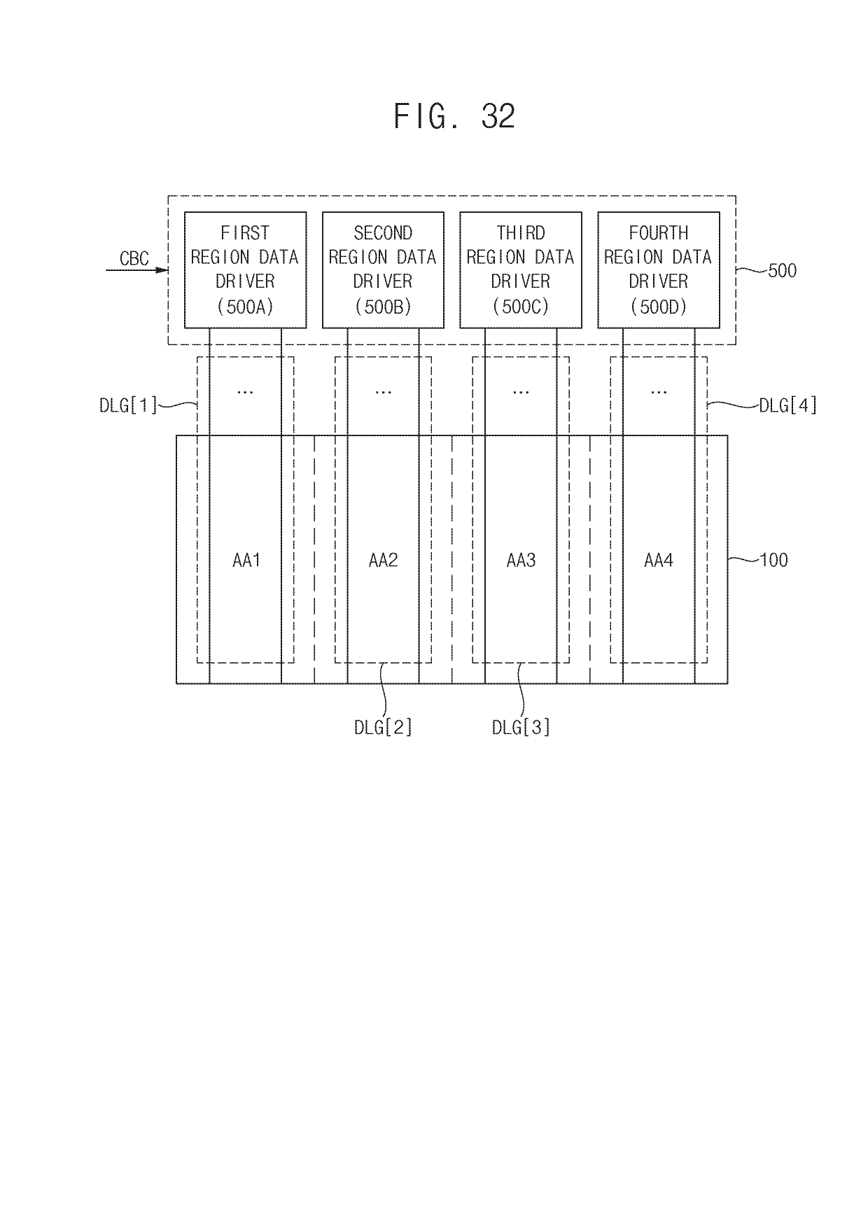

FIG. 32 is a block diagram illustrating an example of a data driver 500 of FIG. 1 and a display panel 100 of FIG. 1.

Referring to FIG. 32, the data driver 500 of FIG. 32 is substantially the same as the data driver 500 of FIG. 25 except that the data driver 500 further includes a fourth region data driver 500D. Accordingly, the same reference numerals will be used to refer to the same and any repetitive explanation concerning the above elements will be omitted.

The fourth region data driver 500D may output the data voltage VDDATA to the fourth display region AA4.

The fourth region data driver 500D may be connected to the pixel circuits PX included in the fourth display region AA4 through a fourth region data line group DLG[4].

For example, when the block control signal BC having an inactivation level is applied to the pixel circuit PX included in the fourth display region AA4, the fourth region data driver 500D may be turned off.

The first region data driver 500A, the second region data driver 500B, the third region data driver 500C, and/or the fourth region data driver 500D may be turned off based on the block-driving control signal CBC. The first region data driver 500A, the second region data driver 500B, the third region data driver 500C, and/or the fourth region data driver 500D may be turned off based on the block-driving control signal CBC, so that a power consumption of the display device 1 may be further reduced.

Additionally, the number of region data drivers which may be turned off may be increased, so that a power consumption of the display device 1 may be further effectively controlled.

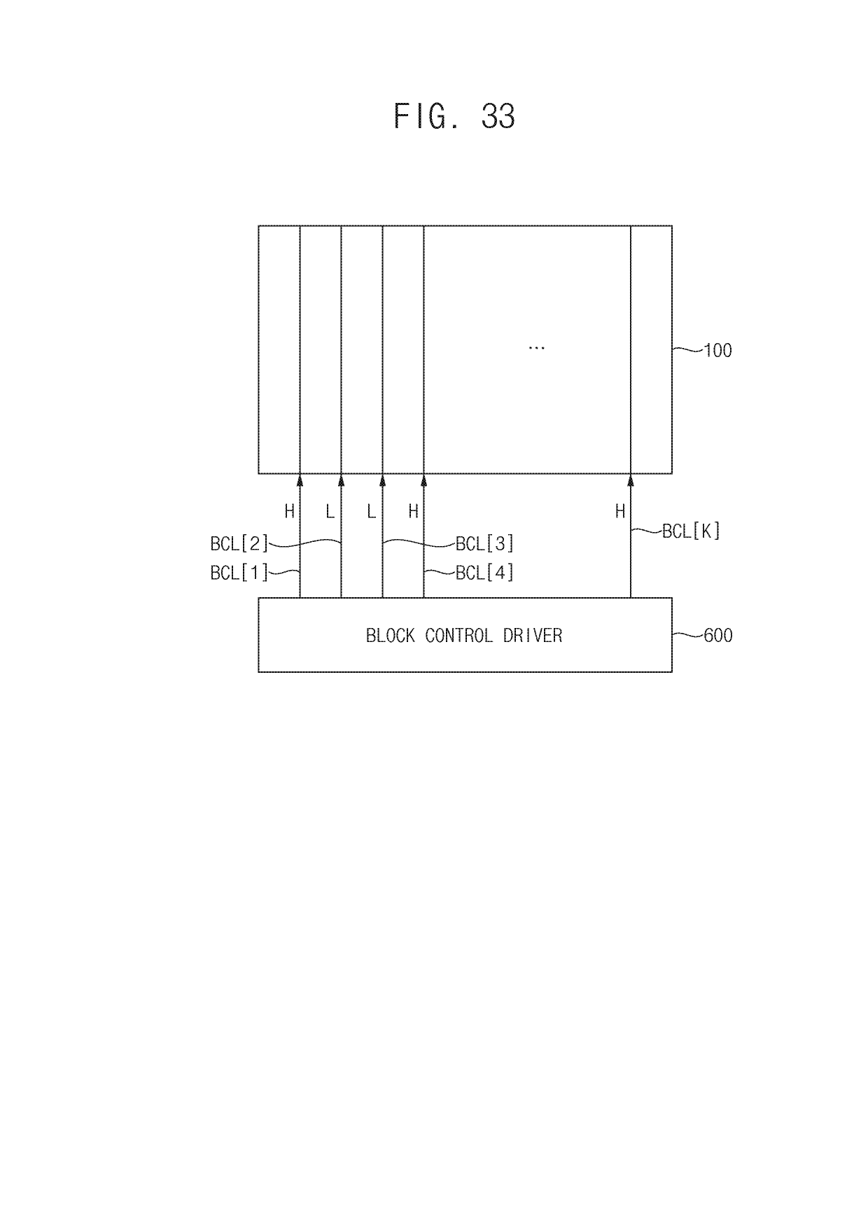

FIG. 33 is a block diagram illustrating an example of a data driver 500 of FIG. 1 and a display panel 100 of FIG. 1.

Referring to FIG. 1 to FIG. 33, each of block control lines BCL may output different levels. For example, a first block control line BCL[1] may output a high level H. For example, a second block control line BCL[2] may output a low level L. For example, a third block control line BCL[3] may output a low level L. For example, a fourth block control line BCL[4] may output the high level H. For example, a K-th block control line BCL[K] may output a high level H. Accordingly, a power consumption of the display device 1 may be further effectively controlled.

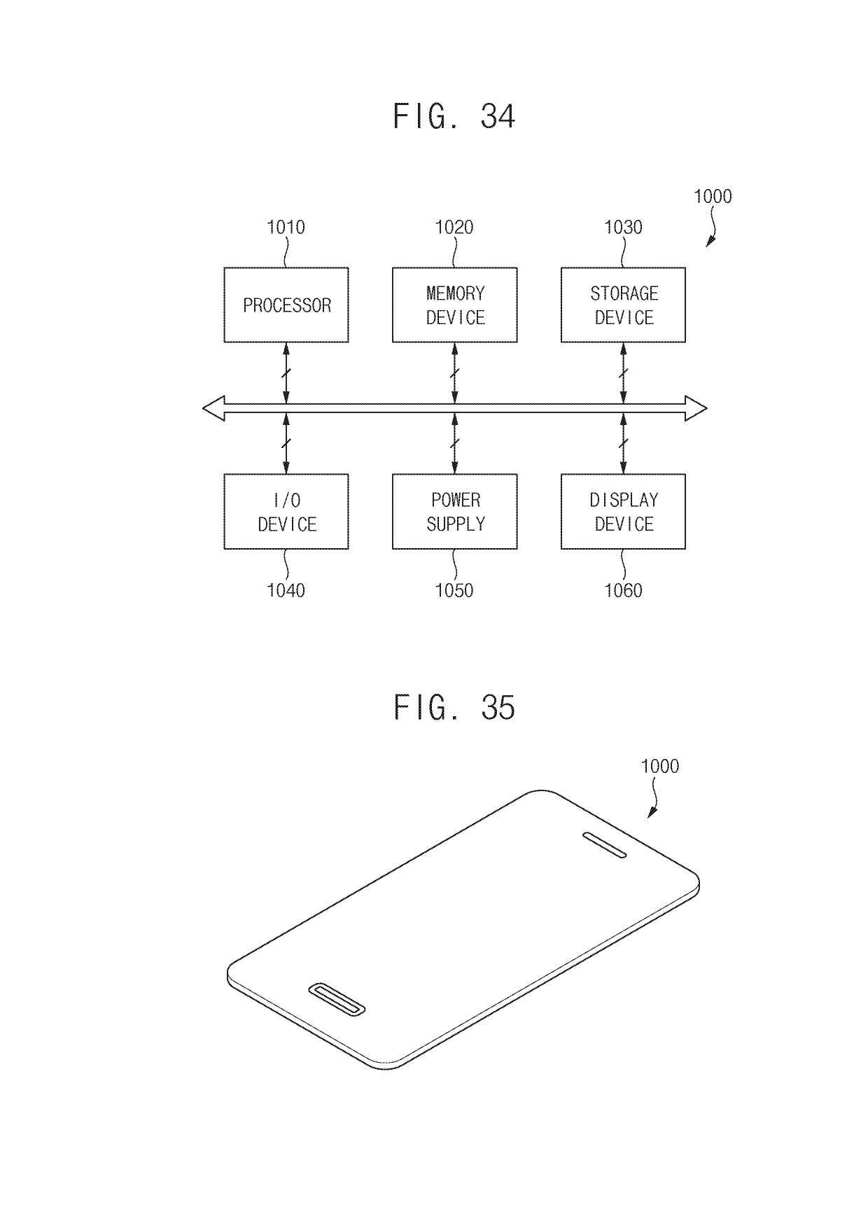

FIG. 34 is a block diagram illustrating an electronic device 1000 according to one or more embodiments of the present disclosure. FIG. 35 is a diagram illustrating an example in which the electronic device of FIG. 34 is implemented as a smart phone.

Referring to FIG. 34, the electronic device 1000 may include a processor 1010, a memory device 1020, a storage device 1030, an input/output (I/O) device 1040, a power supply 1050, and a display device 1060. Here, the display device 1060 may be the display device 1 of FIG. 1. Here, the display device 1060 may be the display device 1A of FIG. 15. Additionally, the electronic device 1000 may further include a plurality of ports for communicating with a video card, a sound card, a memory card, a universal serial bus (USB) device, other electronic device, etc.

In one or more embodiments, as illustrated in FIG. 35, the electronic device 1000 may be implemented as a smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head-mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus, such as a peripheral component interconnection (PCI) bus.

The processor 1010 may output the input image data IMG and the input control signal CONT to the driving controller 200 of FIG. 1.

The memory device 1020 may store data for operations of the electronic device 1000. For example, the memory device 1020 may include at least one non-volatile memory device, such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and/or the like, and/or at least one volatile memory device, such as a dynamic random access memory (DRAM) device, a static random access memory (SRAM) device, a mobile DRAM device, and/or the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display device 1060 may be included in the I/O device 1040. The power supply 1050 may provide power for operations of the electronic device 1000. The display device 1060 may be coupled to other components via the buses or other communication links.

Referring to FIG. 35, the electronic device of the present disclosure is shown implemented as a smartphone, but the present disclosure is not limited thereto. The electronic device may be a television, a monitor, a laptop computer, or a tablet. Additionally, the electronic device may be a car.

The display device according to the embodiments may be applied to a display device included in a computer, a notebook, a mobile phone, a smart phone, a smart pad, a PMP, a PDA, an MP3 player, or the like.

The foregoing is illustrative of the present disclosure and is not to be construed as limiting thereof. Although a few embodiments of the present disclosure have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

What is claimed is:

1. An electronic device comprising:
a display panel comprising a pixel circuit;
a gate emission driver configured to output gate signals to the display panel;
a data driver configured to apply data voltages to the display panel;
a block control driver configured to output a block control signal to the display panel;
a driving controller configured to control the gate emission driver, the data driver, and the block control driver based on an input control signal; and
a processor configured to output the input control signal,
wherein the pixel circuit comprises:
a driving transistor configured to generate a driving current based on a voltage of a first node;
a block control transistor configured to connect the first node and a second node in response to the block control signal;
a write transistor configured to apply the data voltage to the second node in response to a write gate signal;
a reset transistor configured to apply a reference voltage to the second node in response to a reset gate signal; and
a light-emitting element configured to emit light based on the driving current.

2. The electronic device of claim 1, wherein a period in which the pixel circuit is driven comprises:
an address period in which the light-emitting element is configured to emit light based on a data voltage of a present frame, and in which the block control signal has an activation level for turning on the block control transistor; and
a self-scan period in which the light-emitting element is configured to emit light based on a data voltage of a previous frame.

3. The electronic device of claim 2, wherein the address period comprises: a first initialization period, a first write period, and a first emission period,
wherein the reset gate signal and the block control signal have activation levels in the first initialization period,
wherein the write gate signal and the block control signal have activation levels in the first write period, and
wherein the block control transistor is configured to be turned on in the first initialization period and in the first write period.

4. The electronic device of claim 2, wherein the block control signal has an inactivation level for turning off the block control transistor in the self-scan period following the address period.

5. The electronic device of claim 4, wherein the self-scan period comprises a second initialization period, a second write period, and a second emission period, and
wherein the block control signal has an inactivation level in the second initialization period and the second write period.

6. The electronic device of claim 1, wherein the gate emission driver further outputs a first emission signal and a second emission signal,
wherein the pixel circuit further comprises:
a first emission transistor configured to apply a first power voltage to the driving transistor in response to the first emission signal; and
a second emission transistor configured to apply the driving current to the light-emitting element in response to the second emission signal.

7. The electronic device of claim 6, wherein the first emission transistor and the second emission transistor comprise P-type transistors, and the driving transistor, the write transistor, the reset transistor, and the block control transistor comprise N-type transistors.

8. The electronic device of claim 1, wherein the write transistor comprises a control electrode for receiving the write gate signal, a first electrode for receiving the data voltage, and a second electrode connected to the second node,
wherein the reset transistor comprises a control electrode for receiving the reset gate signal, a first electrode for receiving the reference voltage, and a second electrode connected to the second node, and
wherein the block control transistor comprises a control electrode for receiving the block control signal, a first electrode connected to the second node, and a second electrode connected to the first node.

9. The electronic device of claim 8, wherein the gate emission driver further outputs a first emission signal and a second emission signal,
wherein the pixel circuit further comprises:
a first emission transistor comprising a control electrode for receiving the first emission signal, a first electrode for receiving a first power voltage, and a second electrode connected to the driving transistor; and
a second emission transistor comprising a control electrode for receiving the second emission signal, a first electrode connected to a third node, and a second electrode connected to a fourth node,
wherein the driving transistor comprises a control electrode connected to the first node, a first electrode connected to the second electrode of the first emission transistor, and a second electrode connected to the third node, and
wherein the light-emitting element comprises a first electrode connected to the fourth node, and a second electrode for receiving a second power voltage.

10. The electronic device of claim 9, wherein the pixel circuit further comprises a light-emitting element initialization transistor comprising a control electrode for receiving an initialization gate signal, a first electrode for receiving an initialization voltage, and a second electrode connected to the fourth node.

11. The electronic device of claim 1, wherein the gate signals are outputted to the pixel circuit through gate lines extending in a first direction,
wherein the data voltage is applied to the pixel circuit through data lines extending in a second direction that is different from the first direction, and
wherein the block control signal is outputted to the pixel circuit through block control lines extending in the second direction.

12. The electronic device of claim 1, wherein the display panel comprises:
a first display region spaced apart from the gate emission driver in a first direction; and
a second display region adjacent to the first display region in the first direction, and
wherein a driving frequency of the first display region is inconsistent with a driving frequency of the second display region.

13. The electronic device of claim 12, wherein the data driver comprises a first region data driver for applying the data voltage to the first display region, and a second region data driver for applying the data voltage to the second display region,
wherein a period in which the pixel circuit is driven comprises:
an address period in which the light-emitting element is configured to emit light based on a data voltage of a present frame; and
a self-scan period in which the light-emitting element is configured to emit light based on a data voltage of a previous frame, and
wherein the first region data driver is configured to be turned off in the self-scan period.

14. The electronic device of claim 13, wherein the first region data driver comprises an amplifying block, and
wherein a bias voltage is not applied to the amplifying block in the self-scan period.

15. An electronic device comprising:
a display panel comprising a pixel circuit;
a display panel driver configured to drive the display panel based on an input control signal; and
a processor configured to output the input control signal,
wherein the pixel circuit comprises:
a driving transistor configured to generate a driving current based on a voltage of a first node;
a block control transistor configured to connect the first node and a second node in response to a block control signal;
a write transistor configured to apply a data voltage to the second node in response to a write gate signal;
a reset transistor configured to apply a reference voltage to the second node in response to a reset gate signal; and
a light-emitting element configured to emit based on the driving current.

16. The electronic device of claim 15, wherein a period in which the pixel circuit is driven comprises:
an address period in which the light-emitting element is configured to emit light based on a data voltage of a present frame; and
a self-scan period in which the light-emitting element is configured to emit light based on a data voltage of a previous frame, and
wherein the block control signal has an activation level for turning on the block control transistor in the address period.

17. The electronic device of claim 16, wherein the address period comprises a first initialization period, a first write period, and a first emission period,
wherein the reset gate signal and the block control signal have activation levels in the first initialization period,
wherein the write gate signal and the block control signal have activation levels in the first write period, and
wherein the block control transistor is configured to be turned on in the first initialization period and the first write period.

18. The electronic device of claim 16, wherein the block control signal has an inactivation level for turning off the block control transistor in the self-scan period following the address period.

19. The electronic device of claim 18, wherein the self-scan period comprises a second initialization period, a second write period, and a second emission period, and
wherein the block control signal has an inactivation level in the second initialization period and in the second write period.

20. The electronic device of claim 15, wherein the write transistor comprises a control electrode for receiving the write gate signal, a first electrode for receiving the data voltage, and a second electrode connected to the second node,
wherein the reset transistor comprises a control electrode for receiving the reset gate signal, a first electrode for receiving the reference voltage, and a second electrode connected to the second node, and
wherein the block control transistor comprises a control electrode for receiving the block control signal, a first electrode connected to the second node, and a second electrode connected to the first node.
